(19) United States
(12) Patent Application Publication
(10) Pub. No.: US 2017/0063659 A1
(43) Pub. Date: Mar. 2, 2017

(54) GRANULARITY-FOCUSED DISTRIBUTED SYSTEM HIERARCHICAL HEALTH EVALUATION

(71) Applicant: Microsoft Technology Licensing, LLC, Redmond, WA (US)

(72) Inventors: Oana PLATON, Redmond, WA (US); Xun LU, Redmond, WA (US); PehKeong TEH, Bellevue, WA (US); Alex WUN, Renton, WA (US); Vipul MODI, Sammamish, WA (US)

(21) Appl. No.: 14/835,263

(22) Filed: Aug. 25, 2015

(51) Int. Cl. H04L 12/26; H04L 12/733

(52) U.S. Cl. CPC H04L 43/0847; H04L 43/0876; H04L 43/16; H04L 43/06; H04L 45/20

(57) ABSTRACT

A scalable hierarchical health model provides granularly focused evaluations of the health of the health of distributed computational components, e.g., cluster, nodes, applications, services, and the like. A health entity represents a health state of a corresponding computational component. When a health condition is detected, it is reported to a replicated health store by sending a health report which identifies one or more health entities, each of which has the finest granularity of any health entity associated with the health condition. The health report includes a health entity ID, a health property, and a health state of the health property. A health report may also include a health event description written to inform human readers about the event in question. One or more events may be reported in a given health report. The health store aggregates health states according to health policies, thereby providing actionable health information.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A “distributed computational system” (sometimes referred to simply as a “distributed system”) is a computing system in which components located on networked computers communicate with one another and coordinate their actions in pursuit of one or more shared computational goals. Typically, at least some of the components of a distributed system operate concurrently with one another. In many distributed systems, at least some of the components are redundant, in that the system overall can continue making progress toward a shared goal despite the failure of an individual component, after the failure is detected and action is taken to recover from it.

### SUMMARY

Some embodiments are directed to the technical activity of evaluating the computational health of components that are organized hierarchically in a distributed system. Other technical activities pertinent to teachings herein will also become apparent to those of skill in the art.

Some embodiments create health entities in a hierarchy. In the hierarchy, granularity becomes finer as one moves away from the hierarchy's root entity toward (or to) one or more leaf entities of the hierarchy, and becomes coarser as one moves toward the root. In some embodiments, the health entities include one or more of the following: a cluster health entity, a node health entity, an application health entity, a service health entity, a service_partition health entity, a replica health entity, a deployed_application health entity, or a deployed_service_package health entity. Regardless of the particular kinds of entities in the hierarchy, each health entity represents a health state of a corresponding computational resource (cluster, node, application, etc.) in a distributed computational system. Accordingly, the kinds of health entities that are present mirror at least some of the kinds of resources that are present in the corresponding distributed computational system.

In some embodiments, health conditions are associated with at least some of the health entities. When a health condition is detected in the distributed computational system, the health condition may be reported to a health store by sending a health report which identifies a focus of the health condition. Specifically, the health report identifies one or more health entities, each of which has the finest granularity (i.e., is nearest the leaves and/or furthest from the root) of any health entity associated with the health condition. The health store may be replicated. A given health report may include at least a health entity ID of one of the health entities, a health property of the health entity, and a health state of the health property, with the health entity IDs identifying one or more health entities each of which has the finest granularity of any health entity that is associated with a health condition that is reported by the health report. A health report may also include a health event description written to inform human readers about the event in question. One or more events may be reported in a given health report.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor and at least one memory which interact with one another under the control of software in a distributed computational system, and other items in an operating environment which may be present on multiple network nodes, and also illustrating configured storage medium examples;

FIG. 2 is a block diagram illustrating aspects of a granularity-focused distributed system hierarchical health model;

FIG. 3 is a hierarchy diagram illustrating particular kinds of health entities as examples;

FIG. 4 is a data flow diagram illustrating aspects of granularity-focused distributed system hierarchical health evaluation in an example architecture;

FIG. 5 is a block diagram illustrating an example of some possible kinds of information in a health report;

FIG. 6 is a block diagram illustrating examples of possible health conditions that may arise or be found in a distributed computational system;

FIG. 7 is a flow chart illustrating aspects of some process and configured storage medium examples;

FIG. 8 is a health entity hierarchy diagram in which health states of “warning” (indicated by an offset shadow), “error” (indicated by a bold outline), and “ok” (no shadow, no bold) have been aggregated to result in an “error” health state;

FIG. 9 is a health entity hierarchy diagram in which health states of “warning” (offset shadow) and “ok” (no shadow, no bold) have been aggregated to result in a “warning” health state;

FIG. 10 is user interface screen mockup of a diagnostic tool, namely, a distributed system hierarchical health evaluation tool; and

FIG. 11 is user interface screen mockup of an upgrade tool, namely, a distributed system upgrade tool with a hierarchical health evaluation component or accessory tool.

### DETAILED DESCRIPTION

### Acronyms

Some acronyms are defined below, but others may be defined elsewhere herein or require no definition to be understood by one of skill.

ALU: arithmetic and logic unit

API: application program interface

CD: compact disc

CPU: central processing unit

DVD: digital versatile disk or digital video disc

ETW: event tracing for [Microsoft] Windows

FPGA: field-programmable gate array

FPU: floating point processing unit

GPU: graphical processing unit

GUI: graphical user interface

GUID: globally unique identifier

IDE: integrated development environment, sometimes also called “interactive development environment”

RAM: random access memory

REST: representational state transfer

ROM: read only memory

TTL: time to live

URI: universal resource identifier

UTC: universal time coordinated

Note regarding hyperlinks

Portions of this disclosure may be interpreted as containing URLs, hyperlinks, and/or other items which might be considered browser-executable codes, e.g., instances of “fabric:/”. These items are included in the disclosure for their own sake to help describe some embodiments, rather than being included to reference the contents of the web sites or other online or cloud items that they identify. Applicants do not intend to have these URLs, hyperlinks, or other such codes be active links. None of these items are intended to serve as an incorporation by reference of material that is located outside this disclosure document. The United States Patent and Trademark Office will disable these items when preparing this text to be loaded onto its official web database.

Overview

In a distributed platform such as a cloud computing platform, many heterogeneous applications and services can be running at scale. Because distributed computing is complex, it can be difficult to detect something that is going wrong as soon as it happens, or even better, to predict a problem and preemptively prevent impact on the applications and services. But in many cloud services, health monitoring is not part of the service design and architecture stages, which makes the service hard to monitor and manage at scale, which in turn increases the operational cost.

Some proposed solutions are based on capturing and analyzing performance counters and on other information that is not application-specific, in order to determine whether the application in question is running correctly. But these generic solutions typically do not provide developers and administrators with enough insight into the way the distributed system is running for them to figure out accurately and quickly if a problem has occurred, or is imminent, and what exactly is going wrong or will soon go wrong.

In many scenarios, the failure or partial failure of one type of distributed computational system resource may impact many other resources, either at the same time or later. It can be very difficult to identify the ways in which a resource can fail or partially fail, and to identify the ways a given failure or partial failure may impact other parts of the distributed system. Some solutions try to describe a limited set of failures as well as dependencies. Some watchdogs can monitor certain conditions and alert if certain rules are violated. However, if the business logic of the system changes, the watchdog code and/or the rules need to be modified accordingly. Watchdogs typically do not know to use existing information in the distributed system to identify problematic issues as close to their root as possible and as quickly as possible.

Some embodiments described herein evaluate service and system health in distributed systems by aggregating heterogeneous health data reported by different components that have the best local knowledge. The reported health information is kept in a centralized store for easy retrieval and evaluation and is maintained in a hierarchical fashion to reflect dependencies between entities, e.g., if a node goes down, all replicas on it are deemed to become unhealthy.

In some embodiments, a health model includes health entities organized in a hierarchy, health reporters that send health reports on the entities based on local information, and health evaluation code that uses the health information and passed-in health policies to infer whether an entity is healthy.

The health model encourages system and application developers to think about distributed system health from the start, in addition to the business logic and performance concerns that typically receive lots of attention. The health model helps identify conditions of interest and sends developers health related information at the time a condition happens. This information can then be used to infer the health of the entity and its parents in near real-time. Based on this data, administrators or automated external services can take actions to correct potential issues in the services or in a cluster, before problems cascade and cause massive outages. Enabling services to understand and report their own health helps ensure that the services are designed to be watchdog friendly, and helps ensure that a watchdog itself can understand the meaning of health events on the entities it is monitoring and quickly determine whether the entities are healthy or not.

The reporters create health reports based on a local determination of the health of the entity they are monitoring. They do not need to detect global health. This allows the services and platform to scale much better than with other solutions, because monitoring and health determination are distributed among the different monitors within the cluster. They are not handled by a single centralized service at the cluster level which must parse a clamor of messages presenting all the “potentially” useful information emitted by all services.

The health model is built on top of (or conceptually, alongside) the distributed computing system platform model. That is, there is a direct correspondence between entities in the system and health entities, although the distributed system may also contain resources which are not modeled by the health entities. The health hierarchy is similarly built with at least some of the distributed system entity interactions in mind. In some cases, each health entity can have multiple children types and/or multiple parent types. The health of an entity is computed based on reports of its own health, as well as the aggregated health state of all its children. Aggregation is described through health policies that offer enough flexibility to be easily modified based on the environment or application requirements. Distributed system components and watchdogs can report on the entity that provides the most focused granularity (i.e., least coarse granularity) and best describes the health related issue.

Some embodiments specify a hierarchy between entities in the system which describes how they interact and impact each other. Some provide an extensible health reporting model wherein distributed system components and watchdogs can report against entities they are monitoring using their own information that follows a schema. Understanding such reports is not necessarily required in order to evaluate the health of the system, since health states can be represented by an enumeration (e.g., “ok”, “warning”, “error”) and can be aggregated. Some embodiments evaluate the health of an entity using the entire hierarchy, therefore accumulating health knowledge in the system. Some describe or use health policies to evaluate health based on the environment and application-specific information. Some embodiments provide a replicated health store service that maintains all reports and evaluates health. Some provide services and/or components that are able to use the health evaluations to alert administrators or conduct repairs or guide upgrades, for example. Some ensure that only reporters with the right permission can report against the entities, and in some embodiments, users cannot report as if they were the system and cannot depend on system-generated reports to create the health entities. Other variations and combinations are also taught herein.

Some embodiments described herein may be viewed in a broader context. For instance, concepts such as computing, distribution, health, hierarchies, and reporting may be relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems. Other media, systems, and methods involving computing, distribution, health, hierarchies, and/or reporting are outside the present scope. Accordingly, vagueness, mere abstractness, lack of technical character, and accompanying proof problems are also avoided under a proper understanding of the present disclosure.

The technical character of embodiments described herein will be apparent to one of ordinary skill in the art, and will also be apparent in several ways to a wide range of attentive readers. Some embodiments address technical activities such as distributed computing problem or imminent problem detection and reporting. Also, some embodiments include technical components such as computing hardware which interacts with software in a manner beyond the typical interactions within a general purpose computer. For example, in addition to normal interaction such as memory allocation in general, memory reads and write in general, instruction execution in general, and some sort of I/O, some embodiments described herein implement a hierarchy of health entities which mirrors at least a portion of a distributed computational system resource hierarchy. Also, technical effects provided by some embodiments include granularity-focused reporting of distributed system health events. Also, technical advantages of some embodiments include improved localization of problem detection in distributed systems, and reduced error report processing workloads at a cluster level. Other aspects of the technical character will also be apparent to those skilled in the field of distributed computational system health monitoring.

Reference will now be made to exemplary embodiments such as those illustrated in the drawings, and specific language will be used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Quoted terms are defined explicitly, but quotation marks are not used when a term is defined implicitly. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, smartphones, smartwatches, smartbands, cell or mobile phones, other mobile devices having at least a processor and a memory, and/or other device(s) providing one or more processors controlled at least in part by instructions. The instructions may be in the form of firmware or other software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data.

A “logical processor” or “processor” is a single independent hardware thread-processing unit, such as a core in a simultaneous multithreading implementation. As another example, a hyperthreaded quad core chip running two threads per core has eight logical processors. A logical processor includes hardware. The term “logical” is used to prevent a mistaken conclusion that a given chip has at most one processor; “logical processor” and “processor” are used interchangeably herein. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or be loosely coupled. The processors may share a central memory, or each have their own local memory, or both shared and local memories may be present.

“Kernels” include operating systems, hypervisors, virtual machines, BIOS code, and similar hardware interface software.

“Code” means processor instructions, data (which includes constants, variables, and data structures), or both instructions and data.

“Optimize” means to improve, not necessarily to perfect. It may be possible to make further improvements in a program which has been optimized.

“Program” is used broadly herein, to include applications, kernels, drivers, interrupt handlers, firmware, state machines, libraries, and other code written by programmers (who are also referred to as developers).

“Routine” means a function, a procedure, an exception handler, an interrupt handler, or another block of instructions which receives control via a jump and a context save. A context save pushes a return address on a stack or otherwise saves the return address, and may also save register contents to be restored upon return from the routine.

“IoT” or “Internet of Things” means any networked collection of addressable embedded computing nodes. Such nodes are examples of computer systems as defined herein, but they also have at least two of the following characteristics: (a) no local human-readable display; (b) no local keyboard; (c) the primary source of input is sensors that track sources of non-linguistic data; (d) no local rotational disk storage—RAM chips or ROM chips provide the only local memory; (e) no CD or DVD drive; (f) embedment in a household appliance; (g) embedment in an implanted medical device; (h) embedment in a vehicle; (i) embedment in a process automation control system; or (j) a design focused on one of the following: environmental monitoring, civic infrastructure monitoring, industrial equipment monitoring, energy usage monitoring, human or animal health monitoring, or physical transportation system monitoring.

“Resource” refers to one or more components of a distributed computing system. Each of the following is an example of a resource, in at least one of the embodiments discussed herein: cluster, node, application, deployed application, service, service package, partition, replica, deployed service package. This usage differs from other documents or usages in which a resource is, e.g., heap memory space, disk space, or processor cycles.

As used herein, “include” allows additional elements (i.e., includes means comprises) unless otherwise stated. “Consists of” means consists essentially of, or consists entirely of. X consists essentially of Y when the non-Y part of X, if any, can be freely altered, removed, and/or added without altering the functionality of claimed embodiments so far as a claim in question is concerned.

“Process” is sometimes used herein as a term of the computing science arts, and in that technical sense encompasses, e.g., coroutines, threads, tasks, interrupt handlers, application processes, kernel processes, procedures, and object methods. “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Some calculations simply cannot be performed rapidly enough by mental steps or by paper and pencil to timely provide the desired results.

“Computationally” means a computing device (processor plus memory, at least) is being used, and excludes obtaining a result by mere human thought or mere human action alone. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

Throughout this document, use of the optional plural “(s)”, “(es)”, or “(ies)” means that one or more of the indicated feature is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted. Claim language intended to be interpreted as means-plus-function language, if any, will expressly recite that intention.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as aggregating, alerting, associating, avoiding, barring, creating, detecting, diagnosing, emitting, generating, identifying, including, indicating, limiting, making, performing, preventing, repairing, reporting, sending, supporting, upgrading (and aggregates, aggregated, alerts, alerted, etc.) with regard to a destination or other subject may involve intervening action such as forwarding, copying, uploading, downloading, encoding, decoding, compressing, decompressing, encrypting, decrypting, authenticating, invoking, and so on by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. No a claim covers a signal per se. For the purposes of patent protection in the United States, a memory or other computer-readable storage medium is not a propagating signal or a carrier wave outside the scope of patentable subject matter under United States Patent and Trademark Office (USPTO) interpretation of the In re Nuijten case.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise, “computer readable medium” means a computer readable storage medium, not a propagating signal per se.

An “embodiment” herein is an example. The term “embodiment” is not interchangeable with “the invention”. Embodiments may freely share or borrow aspects to create other embodiments (provided the result is operable), even if a resulting aspect combination is not explicitly described per se herein. Requiring each and every permitted combination to be explicitly described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

Operating Environments

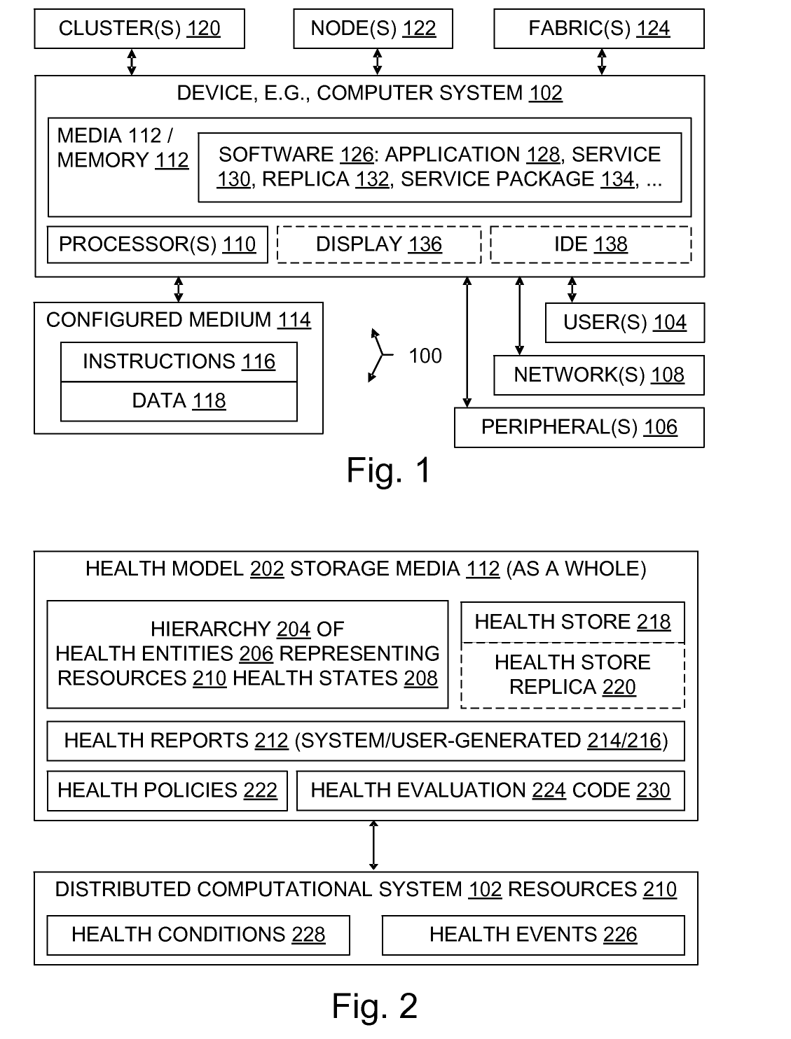

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked. An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A user interface may support interaction between an embodiment and one or more human users. A user interface may include a command line interface, a graphical user interface (GUI), natural user interface (NUI), voice command interface, and/or other interface presentations. A user interface may be generated on a local desktop computer, or on a smart phone, for example, or it may be generated from a web server and sent to a client. The user interface may be generated as part of a service and it may be integrated with other services, such as social networking services. A given operating environment includes devices and infrastructure which support these different user interface generation options and uses.

Natural user interface (NUI) operation may use speech recognition, touch and stylus recognition, gesture recognition both on screen and adjacent to the screen, air gestures, head and eye tracking, voice and speech, vision, touch, gestures, and/or machine intelligence, for example. Some examples of NUI technologies include touch sensitive displays, voice and speech recognition, intention and goal understanding, motion gesture detection using depth cameras (such as stereoscopic camera systems, infrared camera systems, RGB camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (electroencephalograph and related tools).

As another example, a game may be resident on a Microsoft XBOX Live® server (mark of Microsoft Corporation). The game may be purchased from a console and it may be executed in whole or in part on the server, on the console, or both. Multiple users may interact with the game using standard controllers, air gestures, voice, or using a companion device such as a smartphone or a tablet. A given operating environment includes devices and infrastructure which support these different use scenarios.

System administrators, developers, engineers, and end-users are each a particular type of user 104. Automated agents, scripts, playback software, and the like acting on behalf of one or more people may also be users 104. Storage devices and/or networking devices may be considered peripheral equipment in some embodiments. Other computer systems not shown in FIG. 1 may interact in technological ways with the computer system 102 or with another system embodiment using one or more connections to a network 108 via network interface equipment, for example. In particular, one or more devices 102 may form part of or otherwise communicate electronically with devices 102 in a cluster 120, with devices which serve as nodes 122 in a distributed system, and/or with devices 102 in a computing fabric 124. These designations are not necessarily mutually exclusive, e.g., some people of skill in the art refer to nodes as part of a computing cluster.

The computer system 102 includes at least one logical processor 110. The computer system 102, like other suitable systems, also includes one or more computer-readable storage media 112. Media 112 may be of different physical types. The media 112 may be volatile memory, non-volatile memory, fixed in place media, removable media, magnetic media, optical media, solid-state media, and/or of other types of physical durable storage media (as opposed to merely a propagated signal). In particular, a configured medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se.

The medium 114 is configured with instructions 116 that are executable by a processor 110; “executable” is used in a broad sense herein to include machine code, interpretable code, bytecode, and/or code that runs on a virtual machine, for example. The medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, cell phone, or gaming console), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In the illustrated environments 100, software 126 and related artifacts are installed and/or operable, such as one or more applications 128, services 130, replicas 132, and service packages 134. The software 126 and other items shown in the Figures and/or discussed in the text, may each reside partially or entirely within one or more hardware media 112, thereby configuring those media for technical effects which go beyond the “normal” (i.e., least common denominator) interactions inherent in all hardware-software cooperative operation. In addition to processors 110 (CPUs, ALUs, FPUs, and/or GPUs), memory/storage media 112, display(s) 136, and battery(ies), an operating environment may also include other hardware, such as buses, power supplies, wired and wireless network interface cards, and accelerators, for instance, whose respective operations are described herein to the extent not already apparent to one of skill. The display 136 may include one or more touch screens, screens responsive to input from a pen or tablet, or screens solely for output.

A given operating environment 100 may include an Integrated Development Environment (IDE) 138 which provides a developer with a set of coordinated software development tools such as compilers, source code editors, profilers, debuggers, and so on. In particular, some of the suitable operating environments for some embodiments include or help create a Microsoft® Visual Studio® development environment (marks of Microsoft Corporation) configured to support program development. Some suitable operating environments include Java® environments (mark of Oracle America, Inc.), and some include environments which utilize languages such as C++ or C# (“C-Sharp”), but teachings herein are applicable with a wide variety of programming languages, programming models, and programs, as well as with technical endeavors outside the field of software development per se.

One or more items are shown in outline form in the Figures to emphasize that they are not necessarily part of the illustrated operating environment or all embodiments, but may interoperate with items in the operating environment or some embodiments as discussed herein. It does not follow that items not in outline form are necessarily required, in any Figure or any embodiment. In particular, FIG. 1 is provided for convenience; inclusion of an item in FIG. 1 does not imply that the item, or the described use of the item, was known prior to the current innovations.

One of skill will appreciate that the foregoing aspects and other aspects presented herein under “Operating Environments” may also form part of a given embodiment. This document's headings are not intended to provide a strict classification of features into embodiment and non-embodiment feature classes.

Systems

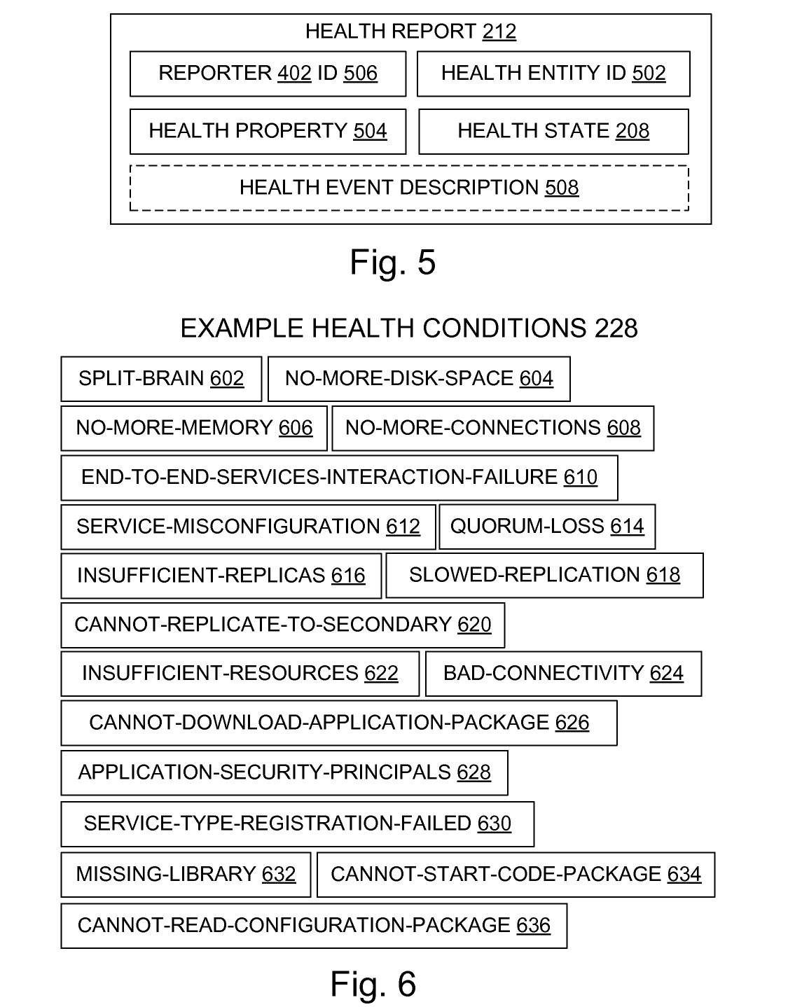

FIGS. 2 through 6 illustrate aspects of an architecture which is suitable for use with some embodiments. A health model 202 includes a hierarchy 204 of health entities 206 which represent health states 208 of resources 210 of a distributed computing system 102. Health reports 212 may include system-generated reports 214 and/or user-generated reports 216. Reports 212 are generated in response to health events 226 detected in the distributed system, which are interpreted as indications of various health conditions 228. Reports 212 are sent to a health store 218 by reporters 402, where the health information in the reports and/or copies of the reports 212 themselves are stored. The health store 218 may include one or more replicas 220. Based on the information reported, and following 720 health policies 222, an evaluator 230 embodiment can provide a current health evaluation 224 of the portion of the distributed system that corresponds to the hierarchy 204 of health entities 206. The health evaluator 230 may include one or more health clients 406. If health is threatened or has failed, alerts 404 can be sent to system administrators.

Some embodiments provide a computer system 102 with a logical processor 110 and a memory medium 112 in operable communication with the logical processor and configured by circuitry, firmware, and/or software to provide technical effects such as granularity-focused health evaluation of a distributed computing system. In some embodiments, a hierarchy 204 of health entities 206 resides at least in part in the memory 112. Each health entity 206 represents a current health state 208 of a corresponding computational resource 210 in a distributed computational system 102.

In some embodiments, the health entities 206 include at least four of the following: a cluster health entity 302 representing cluster 120 health, a node health entity 304 representing node 122 health, an application health entity 306 representing application 128 health, a service health entity 308 representing service 130 health, a service_partition health entity 310 representing partition 312 health, a replica health entity 314 representing replica 132 health, a deployed_application health entity 316 representing the health of an application deployment 318, or a deployed_service_package health entity 320 representing service package 134 health. Alternatively, some embodiments include at least one, or at least two, or at least three, or at least five, or at least six, or at least seven, or all eight, of the listed kinds of entities 206.

In some embodiments, a replicated health store 218 contains health reports 212. In some, each health report 212 includes at least a health entity ID 502 of one of the health entities 206, a health property 504 of the health entity, and a health state 208 of the health property. The health entity IDs 502 identify one or more health entities 206, each of which has the finest (i.e., most focused) granularity of any health entity that is associated with a health condition 228 that is reported by, or led to, the health report. Some reports explicitly identify 506 the reporter that sent the report; other reports may be identified implicitly, e.g., by a report group number or the like. Some reports identify a client that reports, allowing multiple components to report independently even though reports 212 are aggregated together. In some embodiments, reports are unique per triplet of {entity ID 502, source 506, property 504}. Independent reporters can identify themselves with a source ID 506 and report on one or more properties they are focused on. When aggregating health, multiple reports (typically all reports) from different sources about different properties are evaluated.

Some reports 212 include a human-readable health event description 508, e.g., “invalid operation”, “no more disk space”, “out of memory”, “not enough connections”, “could not replicate to secondary node”, “application package download failed”, “library not found”, or the like. Event descriptions 508 may correspond generally to health conditions 228. FIG. 6 lists examples of some health conditions 228, denoted at even reference numbers 602 through 636, but it will be appreciated that other conditions may also be detected in some embodiments, and that conditions listed herein as examples are not necessarily detected in every embodiment.

Health reports 212 may be user-generated (e.g., generated by user-installed watchdog or monitor tasks) and/or generated by the system (e.g., by tasks operating in a kernel address space). In some embodiments, the health states 208 include three enumeration values: an okay state indicating there are no known health issues, a warning state indicating there is at least one health issue but it does not exceed a predetermined threshold, and an error state indicating that an entity in the distributed computational system is unhealthy. Other state 208 values may be used in other embodiments. Health states 208 may also be represented numerically, rather than (or in addition to) being represented as enumerations.

In some embodiments, one or more of the following health conditions 228 are each associated with at least one respective health entity 206: split-brain 602, no-more-disk-space 604, no-more-memory 606, no-more-connections 608, end-to-end-services-interaction-failure 610, service-misconfiguration 612, quorum-loss 614, insufficient-replicas 616, slowed-replication 618, cannot-replicate-to-secondary 620, insufficient-resources 622, bad-connectivity 624, cannot-download-application-package 626, application-security-principals 628, service-type-registration-failed 630, missing-library 632, cannot-start-code-package 634, cannot-read-configuration-package 636. More generally, a given embodiment may include or operate with one, some, or all of a set of health conditions 228 which itself includes two or more of the specific health conditions designated herein by 602 through 636.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a technical system, such as a portion of the Internet of Things, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, which may be present in a given computer system. However, an embodiment may also communicate technical data and/or technical instructions through direct memory access, removable nonvolatile media, or other information storage-retrieval and/or transmission approaches, or an embodiment in a computer system may operate without communicating with other computer systems.

Other than simulation, prototyping, or testing systems which are intentionally restricted to a single machine, embodiments described herein operate in a “cloud” computing environment and/or a “cloud” storage environment in which computing services are not owned but are provided on demand. For example, health reports 212 may be generated on multiple devices/systems 102 in a networked cloud and may be stored in a replicated health store 218 on yet other devices within the cloud, and the health entities 206 may reside partially or entirely on different cloud device(s)/system(s) 102.

Aspects of the Microsoft Azure™ service further illustrate innovations described herein (mark of Microsoft Corporation). A hierarchical health model provides a rich, flexible and extensible reporting and evaluation functionality for System resources 210. System components 402 report out of the box on all resources 210. User services can enrich the health data with information specific to their logic, reported on themselves or other entities in a cluster 120. This health subsystem 202 provides near real-time monitoring capabilities of the state of the cluster and services 130 running in the cluster, which enables administrators 104 or external services to obtain health information and take actions to correct any potential issues in the respective services or cluster. This model 202 also makes the healthy and unhealthy determination of a particular resource 210 the responsibility of the corresponding reporter 402, thereby improving the scalability and manageability of the cloud service. A Health Store 218 keeps health related information about resources 210 in the cluster for easy retrieval and evaluation.

Health entities 206 are organized in a logical hierarchy 204 that captures interactions and dependencies between different distributed system resources 210. In this implementation, the entities and the hierarchy are automatically built by the Health Store 218 when it receives reports 212 from the system components 210.

These health entities 206 support an accurate, granular representation of the health of the many moving pieces 210 in the cluster 120. The finer granularity makes it easier to detect issues and perform corrective actions. For example, if a service 130 is not responding, a different approach might report that the application instance is unhealthy, but that different approach is not optimal because the issue might not be affecting all other services within that application. The availability of granular entities for reporting allows more effective reporting and more focused corrective actions can be taken to resolve the issue. Also, pushing these decisions about how to report and respond to health at a granular level to design time—rather than later when debugging installed resources—makes large cloud services easier to debug, monitor, and subsequently operate. The health hierarchy represents the latest state of the monitored portion of the distributed computing system 102 based on the latest health reports, which can provide almost real-time information. Internal and external watchdogs 402 can report on the same resources as one another, based on application specific logic or custom monitored conditions. The user reports 216 co-exist with the system reports 214; each is a kind of health report 212. In some embodiments, the health client 406 used for reporting internally compacts reports 212 based on entity ID 502, source 506 and property 504. Reports with the same identifiers are replaced so only the last report is sent to the health store 218 for processing, which reduces the unnecessary work done for store. Other optimizations may also occur, e.g., removing all unsent reports for an entity when the entity is deleted. The health client in this example also has logic to optimize network traffic and communication with health store. The health client 406 batches reports based on specified configurations before sending them to the health store. When a health report processing is not successful, the client 406 retries internally until it succeeds. When the health store reaches a certain previously specified load, this health client 406 uses exponential delay to let the store process already queued reports.

In this implementation, users or automated services can evaluate any resource 210 at any point in time. When asked to evaluate the health of a resource, the Health Store 218 health evaluator 230 aggregates all health reports on the resource and also evaluates the health of the children of the resource 210 using the corresponding entities 206. A health aggregation algorithm uses health policies 222 specified in the cluster or in the application configurations. The health evaluation policies can also be passed in with evaluation requests.

In this implementation, three health states 208 are used to describe whether a resource is healthy or not. Any report 212 sent to the Health Store specifies at least one of these states, and any evaluation 224 results in one of these states 208. The possible health states are:

(a) Ok: This indicates 752 the resource is healthy. There are no known issues noticed or reported.
(b) Warning: This indicates 754 the resource experienced or is experiencing some issues but is not yet unhealthy (e.g., unexpected delay that is not causing any functional issue and may fix itself without any special intervention).
(c) Error: This indicates 756 the resource is unhealthy. Action should be taken to fix the resource, so that it can function properly.

As mentioned, system components and internal/external watchdogs 402 can report against the system resources. When reporting, the reporters make a local determination of the health of the monitored resource based on some conditions they are monitoring. The reporters 402 don't need to look at any global state to report aggregated, potentially useful information to a central store. This allows the cloud services and the underlying platform to scale, because the monitoring and health determination is distributed among the different monitors 402 within the cluster. Other approaches, in which systems have a single centralized service at the cluster level parsing all the potentially useful information emitted by all services, hinder scalability and make it difficult or infeasible to collect sufficiently specific information to identify issues and potential issues close to the root cause.

Processes

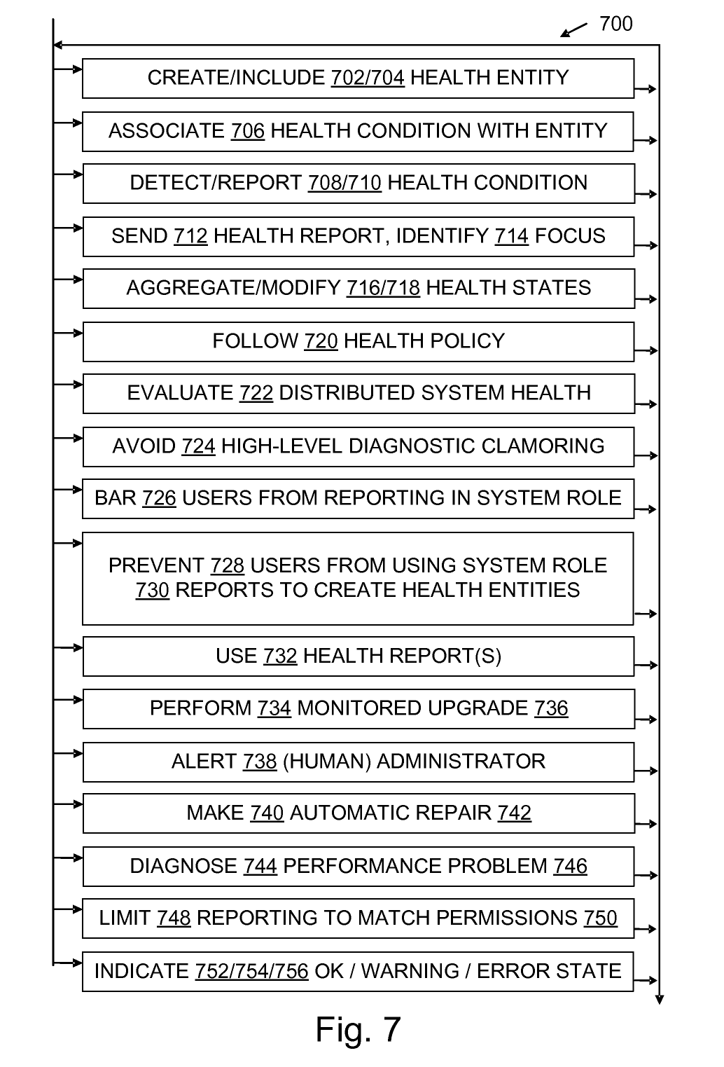

FIG. 7 illustrates some process embodiments in a flowchart 700. Technical processes shown in the Figures or otherwise disclosed may be performed in some embodiments automatically, e.g., by a health model 202 under control of a script or otherwise requiring little or no contemporaneous live user input. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 7. Steps may be performed serially, in a partially overlapping manner, or fully in parallel. The order in which flowchart 700 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from an illustrated flow, if the process performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different technical features, mechanisms, and/or data structures, for instance, and may otherwise depart from the examples provided herein.

In some embodiments, a process for reporting health in a distributed computational system includes creating 702 health entities in a hierarchy. Each health entity represents a health state of a corresponding computational resource in the distributed computational system. The hierarchy resides at least partially in a digital memory and is created at least partially by operation of a digital processor. This process also includes associating 706 health conditions with at least some of the health entities. When a health condition is detected 708 in the distributed computational system, this process includes reporting 710 the health condition to a health store by sending 712 a health report via a network connection. The health report identifies 714 a focus of the health condition, namely, it identifies 714 one or more health entities each of which has the finest granularity of any health entity associated with the health condition.

In some embodiments, the process is further characterized in one or more of the following ways:

the health entities include 704 a cluster health entity (e.g., include 704 by creating this entity and locating it in the hierarchy in a position corresponding to a cluster's position in the distributed computational system), and a split-brain health condition is associated 706 with the cluster health entity (e.g., associate 706 by pairing the condition and the entity or its cluster in a health policy 222);
the health entities include 704 a node health entity, and a no-more-disk-space health condition is associated 706 with the node health entity;
the health entities include 704 a node health entity, and a no-more-memory health condition is associated 706 with the node health entity;
the health entities include 704 a node health entity, and a no-more-connections health condition is associated 706 with the node health entity;
the health entities include 704 an application health entity, and an end-to-end-services-interaction-failure health condition is associated 706 with the application health entity;
the health entities include 704 a service health entity, and a service-misconfiguration health condition is associated 706 with the service health entity;
the health entities include 704 a service_partition health entity, and an insufficient-replicas health condition is associated 706 with the service_partition health entity;
the health entities include 704 a service_partition health entity, and a quorum-loss health condition is associated 706 with the service_partition health entity;
the health entities include 704 a replica health entity, and a cannot-replicate-to-secondary health condition is associated 706 with the replica health entity;
the health entities include 704 a replica health entity, and a slowed-replication health condition is associated 706 with the replica health entity;
the health entities include 704 a replica health entity, and an insufficient-resources health condition is associated 706 with the replica health entity;
the health entities include 704 a replica health entity, and a bad-connectivity health condition is associated 706 with the replica health entity;
the health entities include 704 a deployed_application health entity, and a cannot-download-application-package health condition is associated 706 with the deployed_application health entity;
the health entities include 704 a deployed_application health entity, and an application-security-principals health condition is associated 706 with the deployed_application health entity;
the health entities include 704 a deployed_application health entity, and a service-type-registration-failed health condition is associated 706 with the deployed_application health entity;
the health entities include 704 a deployed_service_package health entity, and a missing-library health condition is associated 706 with the deployed_service_package health entity;
the health entities include 704 a deployed_service_package health entity, and cannot-start-code-package health condition is associated 706 with the deployed_service_package health entity; or
the health entities include 704 a deployed_service_package health entity, and cannot-read-configuration-package health condition is associated 706 with the deployed_service_package health entity.

In some embodiments, the process is further characterized in at least one of the following ways:

the hierarchy 204 includes 704 a cluster health entity, and also includes 704 at least one node health entity which is a descendant of the cluster health entity;
the hierarchy 204 includes 704 a cluster health entity, and also includes 704 at least one application health entity which is a descendant of the cluster health entity;
the hierarchy 204 includes 704 an application health entity, and also includes 704 at least one deployed_application health entity which is a descendant of the application health entity;
the hierarchy 204 includes 704 a deployed_application health entity, and also includes 704 at least one deployed_service_package health entity which is a descendant of the deployed_application health entity;
the hierarchy 204 includes 704 an application health entity, and also includes 704 at least one service health entity which is a descendant of the application health entity;
the hierarchy 204 includes 704 a service health entity, and also includes 704 at least one service_partition health entity which is a descendant of the service health entity; or
the hierarchy 204 includes 704 a service_partition health entity, and also includes 704 at least one replica health entity which is a descendant of the service_partition health entity.

In some embodiments, reporting 710 the health condition involves reporting at least the following: a reporter ID, a health entity ID, a health property of the health entity, and a health state of the health property.

In some embodiments, the process also includes aggregating 716 health states of one or more descendants of a parent health entity while following a health policy, thereby modifying 718 a health state of the parent health entity.

In some embodiments, the process supports health evaluation 722 of the distributed computational system while avoiding 724 diagnostic clamoring, namely, avoiding use of a high-level monitor which receives all diagnostic information emitted by monitors and watchdogs.

In some embodiments, the process involves barring 726 users from reporting 710 in a system role (e.g., a role 730 which has kernel-level access permissions or trust levels), and in some the process includes preventing 728 users 104 from using system role reports 214 to create health entities 206.

Configured Media

Some embodiments include a configured computer-readable storage medium 112. Medium 112 may include disks (magnetic, optical, or otherwise), RAM, EEPROMS or other ROMs, and/or other configurable memory, including in particular computer-readable media (as opposed to mere propagated signals). The storage medium which is configured may be in particular a removable storage medium 114 such as a CD, DVD, or flash memory. A general-purpose memory, which may be removable or not, and may be volatile or not, can be configured into an embodiment using items such as one or more health entity hierarchies 204, health reports 212, health stores 218 and heath evaluators 230, in the form of data 118 and instructions 116, read from a removable medium 114 and/or another source such as a network connection, to form a configured medium. The configured medium 112 is capable of causing a computer system to perform technical process steps for granularity-focused distributed system hierarchical health evaluation as disclosed herein. FIGS. 1 through 7, for instance, accordingly help illustrate configured storage media embodiments and process embodiments, as well as system and process embodiments. In particular, any of the process steps illustrated in FIG. 4 and/or FIG. 7, or otherwise taught herein, may be used to help configure a storage medium to form a configured medium embodiment.

Some embodiments provide or use a computer-readable storage medium configured with data and with instructions that when executed by at least one processor causes the processor(s) to perform a technical process for reporting health in a distributed computational system. The process includes creating 702 health entities in a hierarchy, each health entity representing a health state of a corresponding computational resource in the distributed computational system. In some embodiments, the health entities include at least three of the following: a cluster health entity, a node health entity, an application health entity, a service health entity, a service_partition health entity, a replica health entity, a deployed_application health entity, or a deployed_service_package health entity. The process may also include associating 706 health conditions with at least some of the health entities.

When an associated health condition is detected 708 in the distributed computational system, the process includes reporting 710 the health condition to a health store by sending 712 a health report 212 which identifies a focus of the health condition, namely, identifies 714 one or more health entities each of which has the finest granularity of any health entity associated with the health condition. In some embodiments, the timing and/or frequency of sending 712 reports can be adjusted by an administrator, e.g., to help make the health store more robust under load. In some embodiments, the health report includes at least the following: a reporter ID, a health entity ID, a health property of the health entity, a health state of the health property, and a human-readable health event description.

In some embodiments, the process further includes using 732 health reports which are stored in the health store as a basis for at least one of the following: performing 734 a monitored upgrade 736 to at least a portion of the distributed computational system, alerting 738 a human administrator to a condition in at least a portion of the distributed computational system, making 740 an automatic repair 742 to at least a portion of the distributed computational system, diagnosing 744 a performance problem 746 in at least a portion of the distributed computational system 102.

In some embodiments, the process limits 748 reporting against a given health entity to reporting which is done by reporters that have a specified permission, as opposed to accepting all reports, for example.

### Additional Examples

Additional details and design considerations are provided below. As with the other examples herein, the features described may be used individually and/or in combination, or not at all, in a given embodiment.

Those of skill will understand that implementation details may pertain to specific code, such as specific APIs and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

The following discussion is excerpted and/or otherwise derived from Microsoft Azure™ documentation (mark of Microsoft Corporation). Some material has been reformatted to comply with Patent Office regulations. Microsoft Azure™ products and services are implemented by Microsoft Corporation. Aspects of the Azure™ software and/or documentation are consistent with or otherwise illustrate aspects of the embodiments described herein. However, it will be understood that Azure™ documentation and/or implementation choices do not necessarily constrain the scope of such embodiments, and likewise that Azure™ software or services and/or their documentation contain features that lie outside the scope of such embodiments; additional information about Azure™ software and services is available online. It will also be understood that the discussion below is provided in part as an aid to readers who are not necessarily of ordinary skill in the art, and thus may contain and/or omit details whose recitation below is not strictly required to support the present disclosure.

Note also that in this discussion of Azure™ software and services and related items, the term “entity” may be used to refer to resources 210 in addition to being used to refer to health entities 206; which meaning is intended at a given point in the discussion will be apparent to one of skill in the art. Also, the “service fabric” in this discussion is an example of a distributed computational system 102.

I. Introduction to Service Fabric Health Monitoring

Service Fabric introduces a health model that provides flexible and extensible health evaluation and reporting, with near real-time monitoring of the state of the cluster and of the services running in it. One can easily obtain the health information and take actions to correct potential issues before they cascade. The typical model is that services send reports based on their local view and the information is aggregated to provide an overall cluster level view.

Service Fabric components use this health model 202 to report their current state, and developers can use the same mechanism to report health from their applications. Health reporting quality and richness for custom conditions will help determine how easy it is to detect and fix issues for a running application.

This Health subsystem originated as an aid to monitored upgrades. Service Fabric provides monitored upgrades that know how to upgrade a cluster or an application with no down time, minimum to no user intervention and with full cluster and application availability. To do this, the upgrade checks health based on configured upgrade policies and allows upgrade to proceed only when health respects desired thresholds. Otherwise, the upgrade is either automatically rolled back or paused to give administrators a chance to fix the issues.

I(a). Health Store

The Health Store 218 keeps health related information about entities in the cluster for easy retrieval and evaluation. It is implemented as a Service Fabric persisted stateful service to ensure high availability and scalability. It is part of the fabric:/System application and is available as soon as the cluster is up and running.

I(b). Health Entities and Hierarchy

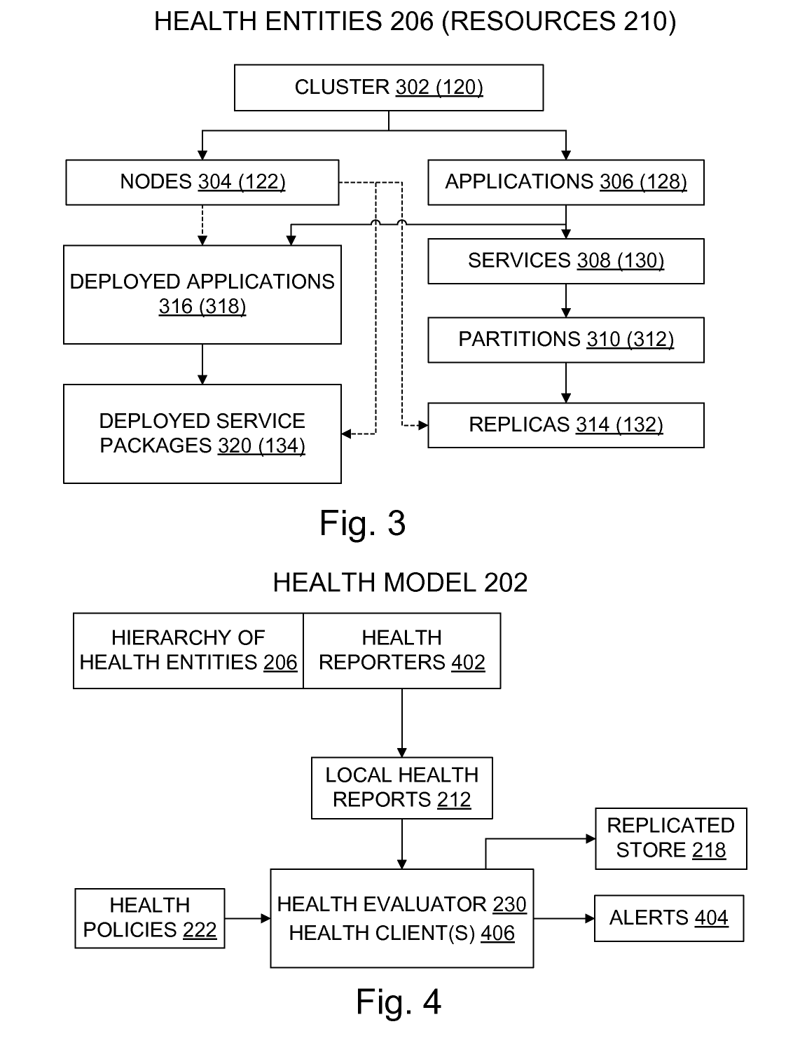

The health entities 206 are organized in a logical hierarchy 204 that captures interactions and dependencies between different entities, as illustrated e.g., in FIG. 3. The entities 206 and the hierarchy are automatically built by the Health Store based on reports 212 received from the Service Fabric components.

The health entities mirror the Service Fabric entities 210 (e.g., a health application entity matches an application instance deployed in the cluster, a health node entity 304 matches a Service Fabric cluster node 122, and so on). The health hierarchy captures the interactions of the system entities and is the basis for advanced health evaluation. The health entities and hierarchy allow for effective reporting, debugging and monitoring of the cluster and applications. The health model allows an accurate, finely granular representation of the health of the many moving pieces in the cluster.

FIG. 3 shows one implementation's approach, with the health entities 206 organized in a hierarchy 204 based on parent-children relationships. In this example, the health entities are as follows.

Cluster 302. Represents the health of a Service Fabric cluster 120. Cluster health reports describe conditions that affect the entire cluster and can't be narrowed down to one or more unhealthy children. Example: split-brain of the cluster due to network partitioning or communication issues.

Node 304. Represents the health of a Service Fabric node 122, e.g., one virtual machine or operating system. Node health reports describe conditions that affect the node functionality and typically affect all the deployed entities running on it. Example: node is out of disk space (or other machine wide property such as memory, connections, etc.) or node is down. The node entity is identified by the node name (string).

Application 306. Represents the health of an application instance 128 running in the cluster. Application health reports describe conditions that affect the overall health of the application and can't be narrowed down to individual children (services or deployed applications). Example: the end to end interaction between different services in the application. The application entity is identified by the application name (a URI).

Service 308. Represents the health of a service 130 running in the cluster. Service health reports describe conditions that affect the overall health of the service, and can't be narrowed down to a partition or a replica. Example: a service configuration (such as port or external file share) that is causing issues for all partitions. The service entity is identified by the service name (a URI).

Partition 310. Represents the health of a service partition 312. Partition health reports are not replica-specific, e.g., they describe conditions that affect the entire replica set. Example: the number of replicas is below target count, or partition is in quorum loss. A partition entity is identified by a partition id (a GUID).

Replica 314. Represents the health of a stateful service replica 132 or a stateless service instance. This is the smallest unit watchdogs and system components can report on for an application. Example: For stateful services, primary replica can report if it can't replicate operations to secondaries or replication is not proceeding at the expected pace. A stateless instance can report if it is running out of resources or has connectivity issues. The replica entity is identified by the partition id (a GUID) and the replica or instance id (a long).

DeployedApplication 316. Represents the health of an application running on a node, designated at 318. Deployed application health reports describe conditions specific to the application on the node that can't be narrowed down to service packages deployed on the same node. Example: the application package can't be downloaded on that node or there is an issue setting up application security principals on the node. The deployed application is identified by application name (a URI) and node name (a string).

DeployedServicePackage 320. Represents the health of a service package 134 of an application running in a node in the cluster. It describes conditions specific to a service package that do not affect the other service packages on the same node for the same application. Example: a code package in the service package cannot be started or configuration package cannot be read. The deployed service package is identified by application name (a URI), node name (a string) and service manifest name (a string).

The granularity of this health model 202 makes it easier to detect and correct issues. For example, if a service is not responding, it is feasible to report that the application instance is unhealthy; however, that report is not ideal because the issue might not be affecting all services within that application. The report would instead be applied on the unhealthy service, or, if more information points to a specific child partition, on that partition. The data will automatically surface through the hierarchy: an unhealthy partition will be made visible at service and application levels. This will help pinpoint and resolve the root cause of the issues faster.

The health hierarchy is composed with parent-children relationships. This cluster 302 is composed of (that is, has children including) nodes and applications; applications have services and deployed applications; deployed applications have deployed service packages. Services have partitions, and each partition has one or more replicas. There is a special relationship between nodes and deployed entities. If a node is unhealthy as reported by its authority System component (e.g., a Failover Manager Service), it will affect the deployed applications, service packages and replicas deployed on it. The health hierarchy represents the latest state of the distributed system based on the latest health reports, which is almost real-time information. Internal and external watchdogs can report on the same entities based on application specific logic or custom monitored conditions. The user reports co-exist with the system reports. Investing time on planning how to report and respond to health while designing the service makes large cloud services easier to debug, monitor, and subsequently operate.

In some examples, an entity 210 can be a host of one or more other entities 210. The health model 202 accordingly supports designation of a health entity 206 as a host of one or more other health entities 206. If the host becomes unhealthy, then all entities hosted by it automatically become likewise unhealthy.

Thus, if a host transitions from an OK state to a Warning state, all entities hosted by it automatically move to a Warning state. If a host transitions to an Error state, all entities hosted by it automatically move to an Error state.

I(c). Health States

Service Fabric uses three health states 208 to describe whether an entity 210 is healthy or not: Ok, Warning and Error. Any report sent to the Health Store specifies one of these states. The health evaluation result is one of these states. The possible health states are Ok, Warning, and Error.

Ok. The entity is healthy. There are no known issues reported on it or its children (if any).

Warning. The entity experiences some issues but it is not yet unhealthy, e.g., unexpected delay that it is not causing any functional issue. In some cases, the warning condition may fix itself without any special intervention, and it is useful to provide visibility into what is going on. In other cases, the Warning condition may degrade into a severe problem without user intervention.

Error. The entity is unhealthy. Action should be taken to fix the state of the entity, as it can't function properly.

Another possible state is Unknown, indicating the entity 206 doesn't exist in the health store. This result can be obtained from distributed queries like those that get the Service Fabric nodes or applications. These queries merge results from multiple system components. If another system component has an entity that has not reached the health store yet or that has been cleaned up from health store, the merged query will populate health result with ‘Unknown’ health state.

I(d). Health Policies

The Health Store applies 720 health policies 222 to determine whether an entity is healthy based on its reports and its children. The health policies can be specified in the cluster manifest (for cluster and node health evaluation) or the application manifest (for application evaluation and any of its children), for example. The health evaluation requests can also pass in custom health evaluation policies, which will only be used for that evaluation. By default, Service Fabric applies a strict rule that everything must be healthy in the parent-children hierarchical relationship; as long as one of the children has one unhealthy event, the parent is considered unhealthy.

I(e). Cluster Health Policy

A cluster health policy is used to evaluate cluster health state and node health states. It can be defined in the cluster manifest. If not present, it defaults to the default policy (0 tolerated failures). It contains:

ConsiderWarningAsError. Specifies whether to treat Warning health reports as errors during health evaluation. Default: False. This is omitted from some embodiments.
MaxPercentUnhealthyApplications. Maximum tolerated percentage of applications that can be unhealthy before the cluster is considered in Error.
MaxPercentUnhealthyNodes. Maximum tolerated percentage of nodes that can be unhealthy before the cluster is considered in Error. In large clusters, there will always be nodes down or out for repairs, so this percentage should be configured to tolerate that. The following is an excerpt from a cluster manifest:

<FabricSettings>
<Section Name=“HealthManager/ClusterHealthPolicy”>

<Parameter Name=“ConsiderWarningAsError” Value=“False” />
<Parameter Name=“MaxPercentUnhealthyApplications”
Value=“0” />
<Parameter Name=“MaxPercentUnhealthyNodes” Value=“20” />

</Section>
</FabricSettings>

In some embodiments, cluster health policy also contains a field for an application type health policy map. This provides an ability to express MaxPercentUnhealthyApplications in ClusterHealthPolicy. For application types that have special requirements, administrators can add entries in the map to define how the instances of that application type should be evaluated. As a result, the rest of the applications are evaluated using the global MaxPercentUnhealthyApplications, while the special applications are evaluated per specified percentages. This may be used, for example, when a cluster has thousands of applications, of which a particular application type is very important to the cluster functionality and has a small number of applications. The administrator wants to tolerate some failures in the cluster but wants to know quickly when these very important apps become unhealthy. For instance, the administrator could set MaxPercentUnhealthyApplications to 10% of unhealthy applications in general but set the threshold to (zero) 0% for these very important apps.

I(f). Application Health Policy

An application health policy describes how evaluation of events and children states aggregation is done for application and its children. It can be defined in the application manifest, ApplicationManifest.xml in the application package. If not specified, Service Fabric assumes the entity to be unhealthy if is has a health report or a child at Warning or Error health state. The configurable policies are:

ConsiderWarningAsError. Specifies whether to treat Warning health reports as errors during health evaluation. Default: False.
MaxPercentUnhealthyDeployedApplications. Maximum tolerated percentage of deployed applications that can be unhealthy before the application is considered in Error. This is calculated by dividing the number of unhealthy deployed applications over the number of nodes that the applications is currently deployed on in the cluster. The computation rounds up to tolerate one failure on small number of nodes. Default: 0%.
DefaultServiceTypeHealthPolicy. Specifies the default service type health policy, which will replace the default health policy for all service types in the application.
ServiceTypeHealthPolicyMap. Map with service health policies per service type, which replace the default service type health policy for the specified service types. For example, in an application that contains a stateless Gateway service type and a stateful Engine service type, the health policy for the stateless and stateful service can be configured differently. Specifying policy per service types allows a more granular control of the health of the service.

I(g). Service Type Health Policy

A service type health policy specifies how to evaluate and aggregate children of service. It contains:

MaxPercentUnhealthyPartitionsPerService. Maximum tolerated percentage of unhealthy partitions before a service is considered unhealthy. Default: 0%.
MaxPercentUnhealthyReplicasPerPartition. Maximum tolerated percentage of unhealthy replicas before a partition is considered unhealthy. Default: 0%.
MaxPercentUnhealthyServices. Maximum tolerated percentage of unhealthy services before the application is considered unhealthy. Default: 0%
The following is an excerpt from an application manifest:

```
  <Policies>
    <HealthPolicy ConsiderWarningAsError=“true”
MaxPercentUnhealthyDeployedApplications=“20”>
      <DefaultServiceTypeHealthPolicy
          MaxPercentUnhealthyServices=“0”
          MaxPercentUnhealthyPartitionsPerService=“10”
          MaxPercentUnhealthyReplicasPerPartition=“0”/>
      <ServiceTypeHealthPolicy
      ServiceTypeName=“FrontEndServiceType”
          MaxPercentUnhealthyServices=“0”
          MaxPercentUnhealthyPartitionsPerService=“20”
          MaxPercentUnhealthyReplicasPerPartition=“0”/>
      <ServiceTypeHealthPolicy
      ServiceTypeName=“BackEndServiceType”
          MaxPercentUnhealthyServices=“20”
          MaxPercentUnhealthyPartitionsPerService=“0”
          MaxPercentUnhealthyReplicasPerPartition=“0”>
      </ServiceTypeHealthPolicy>
    </HealthPolicy>
  </Policies>
```

I(h). Health Evaluation

Users or automated services can evaluate health for any entity at any point in time. To evaluate 722 an entity health, the Health Store aggregates 716 all health reports on the entity and evaluates all its children (when applicable). The health aggregation algorithm uses health policies that specify how to evaluate health reports as well as how to aggregate children health states (when applicable).

I(i). Health Reports Aggregation

One entity can have multiple health reports sent by different reporters 402 (system components or watchdogs) on different properties 504. The aggregation uses the associated health policies, in particular the ConsiderWarningAsError member of application or cluster health policy, which specifies how to evaluate warnings.

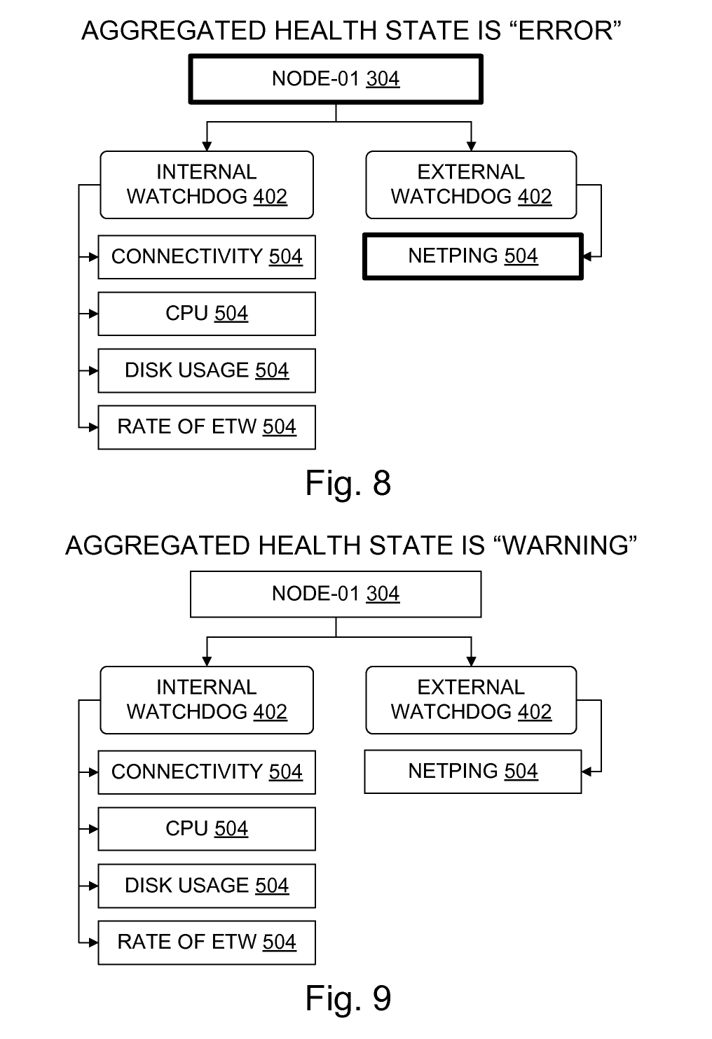

The aggregated health state is triggered by the worst health reports on the entity. If there is at least one Error health report, the aggregated health state is Error. FIG. 8 shows an example in which an error health report in a NetPing property (bold outline) triggers an Error state 208 in a Node health entity.

If there are no Error reports, and one or more Warnings, the aggregated health state is either Warning or Error, depending on the ConsiderWarningAsError policy flag. FIG. 9 shows an example with Warning Report and ConsiderWarningAsError false (by default) in which the aggregated health state is Warning (offset shadow).

I(j). Children Health Aggregation

The aggregated health state of an entity reflects the children health states (when applicable). The algorithm for aggregating children health states uses the health policies applicable based on the entity type. After evaluating all children, the Health Store aggregates the health states based on the configured max percent unhealthy taken from the policy based on the entity and child type.

If all children have Ok states, the children aggregated health state is Ok.
If children have Ok and Warning states, the children aggregated health state is Warning.
If there are children with Error states that do not respect max allowed percentage of unhealthy children, the aggregated health state is error.
If the children with Error states respect the max allowed percentage of unhealthy children, the aggregated health state is Warning.

I(k). Health Reporting

System components and internal/external watchdogs can report against the Service Fabric entities. The reporters 402 make a local determination of the health of the monitored entity 210 based on some conditions 228 they are monitoring. They do not necessarily look at any global state or aggregate data, and doing so would make the reporters into complex organisms that look at many things in order to infer what information to send. To send health data to the health store, the reporters identify the affected entity 210 and create a health report 212. The report can then be sent through an API with FabricClient.HealthManager.ReportHealth, through a shell such as PowerShell or through REST.

I(l). Health Reports

The health reports 212 for each of the entities in the cluster contain the following information:

SourceId. A string that uniquely identifies the reporter of the health event.
Entity identifier. Identifies the entity on which the report is applied on. It differs based on the entity type: Cluster: none; Node: node name (string); Application: application name (URI), represents the name of the application instance deployed in the cluster; Service: service name (URI), represents the name of the service instance deployed in the cluster; Partition: partition id (GUID), represents the partition unique identifier; Replica: the stateful service replica id or the stateless service instance id (Int64); DeployedApplication: application name (URI) and node name (string); DeployedServicePackage: application name (URI), node name (string) and service manifest name (string).
Property. A string (not a fixed enumeration) that allows the reporter to categorize the health event for a specific property of the entity. For example, reporter A can report health on Node01 “storage” property and reporter B can report health on Node01 “connectivity” property. Both these reports are treated as separate health events in the health store for the Node01 entity.
Description A string that allows the reporter to provide detail information about the health event. SourceId, Property and HealthState should fully describe the report. The description adds human readable information about the report to make it easier for administrators and users to understand.
HealthState. An enumeration that describes the health state of the report. The values accepted in this implementation are OK, Warning, and Error.
TimeToLive. A timespan that indicates how long the health report is valid. Coupled with RemoveWhenExpired, it lets the HealthStore know how to evaluate expired events. By default, the value is infinite and the report is valid forever.
RemoveWhenExpired. A boolean. If set to true, the expired health report is automatically removed from health store and it doesn't impact entity health evaluation. This is used when the report is valid for a period of time only and the reporter doesn't need to explicitly clear it out. It's also used to delete reports from health store. E.g., a watchdog is changed and stops sending reports with previous source and property. So it can send a report with small TTL and RemoveWhenExpired to clear up any previous state from Health Store. If set to false, the expired report is treated as an error on health evaluation. It signals to the health store that the source should report periodically on this property; if it doesn't, then there must be something wrong with the watchdog. The watchdog health is captured by considering the event as error.
SequenceNumber. A positive integer that needs to be ever increasing, as it represents the order of the reports. Some examples report in a sequence stream where every report is sent only once. SequenceNumber is used by Health Store to detect stale reports, received late because of network delays or other issues. Reports are rejected if the sequence number is less or equal the latest applied one for the same entity, source and property. The sequence number is auto-generated if not specified. This implementation only puts in the sequence number when reporting on state transitions: the source remembers what reports it sent and persists the information for recovery on failover.
The SourceId, entity identifier, Property and HealthState are placed in every health report. The SourceId string is not allowed to start with prefix “System.”, which is reserved for System reports. For the same entity, there is only one report for the same source and property; if multiple reports are generated for the same source and property, they override each other, either on health client 406 side (if they are batched) or on the health store 218 side. The replacement is done based on sequence number: newer reports (with higher sequence number) replace older reports.

I(m). Health Events

Internally, the Health Store keeps health events 226, which contain all the information from the reports plus additional metadata, such as time the report was given to the health client 406 and time it was modified on the server side. The health events are returned by health queries.

The added metadata contains:

SourceUtcTimestamp: the time the report was given to the health client (UTC)
LastModifiedUtcTimestamp: the time the report was last modified on the server side (UTC)
IsExpired: flag to indicate whether the report was expired at the time the query was executed by the Health Store. An event can be expired only if RemoveWhenExpired is false; otherwise, the event is not returned by query, it is removed from store.
LastOkTransitionAt, LastWarningTransitionAt, LastErrorTransitionAt: last time for Ok/Warning/Error transitions. These fields give the history of the transition of the health states for the event.
The state transition fields can be used for smarter alerting 738 or historical health event information. They enable scenarios such as:
Alert when a property has been at Warning/Error for more than X minutes. This avoids alerting on temporary conditions. Eg: alert if the health state has been Warning for more than 5 minutes can be translated into (HealthState==Warning and Now−LastWarningTransitionTime>5 minutes).
Alert only on conditions that changed in the last X minutes. If a report is at Error since before that, it can be ignored (because it was already signaled previously). If a property is toggling between Warning and Error, determine how long it has been unhealthy (i.e. not Ok). Eg: alert if the property wasn't healthy for more than 5 minutes can be translated into: (HealthState !=Ok and Now−LastOkTransitionTime>5 minutes).

I(n). Example: Report and Evaluate Application Health

The following example sends a health report through PowerShell on the application named fabric:/WordCount from the source MyWatchdog. The health report contains information about the health property Availability in an Error health state, with infinite TTL. Then it queries the application health, which will return aggregated health state error and the reported health event as part of the list of health events.

PS C:\> Send-ServiceFabricApplicationHealthReport -ApplicationName
fabric:/WordCount -SourceId “MyWatchdog” -HealthProperty “Availability” -
HealthState Error
PS C:\> Get-ServiceFabricApplicationHealth fabric:/WordCount

| | |
|---|---|
| ApplicationName | : fabric:/WordCount |
| AggregatedHealthState | : Error |
| UnhealthyEvaluations | : |

Error event: SourceId=‘MyWatchdog’, Property=‘Availability’.

| | |
|---|---|
| ServiceHealthStates | : |

| ServiceName | : fabric:/WordCount/WordCount.Service |
|---|---|
| AggregatedHealthState : Warning | |
| ServiceName | : |

fabric:/WordCount/WordCount.WebService

AggregatedHealthState : Ok

DeployedApplicationHealthStates :

| ApplicationName | : fabric:/WordCount |
|---|---|
| NodeName | : Node.4 |
| AggregatedHealthState : Ok | |
| ApplicationName | : fabric:/WordCount |
| NodeName | : Node.1 |
| AggregatedHealthState : Ok | |
| ApplicationName | : fabric:/WordCount |
| NodeName | : Node.5 |
| AggregatedHealthState : Ok | |
| ApplicationName | : fabric:/WordCount |
| NodeName | : Node.2 |
| AggregatedHealthState : Ok | |
| ApplicationName | : fabric:/WordCount |
| NodeName | : Node.3 |

| | AggregatedHealthState : Ok | |
|---|---|---|
| HealthEvents | : | |
| | SourceId | : System.CM |
| | Property | : State |
| | HealthState | : Ok |

| | |
|---|---|
| SequenceNumber | : 5102 |

| SentAt | : 4/15/2015 5:29:15 PM |
|---|---|
| ReceivedAt | : 4/15/2015 5:29:15 PM |
| TTL | : Infinite |
| Description | : Application has been created. |
| RemoveWhenExpired : False | |
| IsExpired | : False |
| Transitions | : ->Ok = 4/15/2015 5:29:15 PM |
| SourceId | : MyWatchdog |
| Property | : Availability |
| HealthState | : Error |

| | |
|---|---|
| SequenceNumber | : 130736794527105907 |

| SentAt | : 4/16/2015 5:37:32 PM |
|---|---|
| ReceivedAt | : 4/16/2015 5:37:32 PM |
| TTL | : Infinite |
| Description | : |
| RemoveWhenExpired : False | |
| IsExpired | : False |
| Transitions | : ->Error = 4/16/2015 5:37:32 PM |

I(o). Health Model Usage

The health model allows the cloud services and the underlying Service Fabric platform to scale, because the monitoring and health determination is distributed among the different monitors within the cluster. Other systems have a single centralized service at the cluster level parsing all the potentially useful information emitted by services. This hinders their scalability and it doesn't allow them to collect very specific information to help identify issues and potential issues as close to the root cause as possible. The health model can be heavily used for monitoring and diagnosis, for evaluating the cluster and application health, and for monitored upgrades. Other services can also use health data to do automatic repairs, to build cluster health history and to issue alerts on certain conditions.

II. How to View Service Fabric Health Reports

Service Fabric introduces a Health Model implementation with health entities on which System components and watchdogs can report local conditions they are monitoring. A Health Store aggregates all health data to determine whether entities are healthy. Out of the box, the cluster is populated with health reports sent by the System components.

Service Fabric provides multiple ways to get the entities' aggregated health, namely, a Service Fabric Explorer tool, other visualization tools, Health queries (through PowerShell/API/REST, and general queries that return a list of entities that have health as one of the properties (through PowerShell/API/REST).

To demonstrate these options, let's use a local cluster with 5 nodes. In addition to fabric:/System application (which exists out of the box), there are some other applications deployed, one of which is fabric:/WordCount. This application contains a stateful service configured with 7 replicas. Since there are only 5 nodes, system components will flag that the partition is below target count with a Warning.

```
<Service Name=“WordCount.Service”>
  <StatefulService ServiceTypeName=“WordCount.Service”
MinReplicaSetSize=“2” TargetReplicaSetSize=“7”>
  <UniformInt64Partition PartitionCount=“1” LowKey=“1”
  HighKey=“26” />
  </StatefulService>
</Service>
```

II(a). Health in Service Fabric Explorer

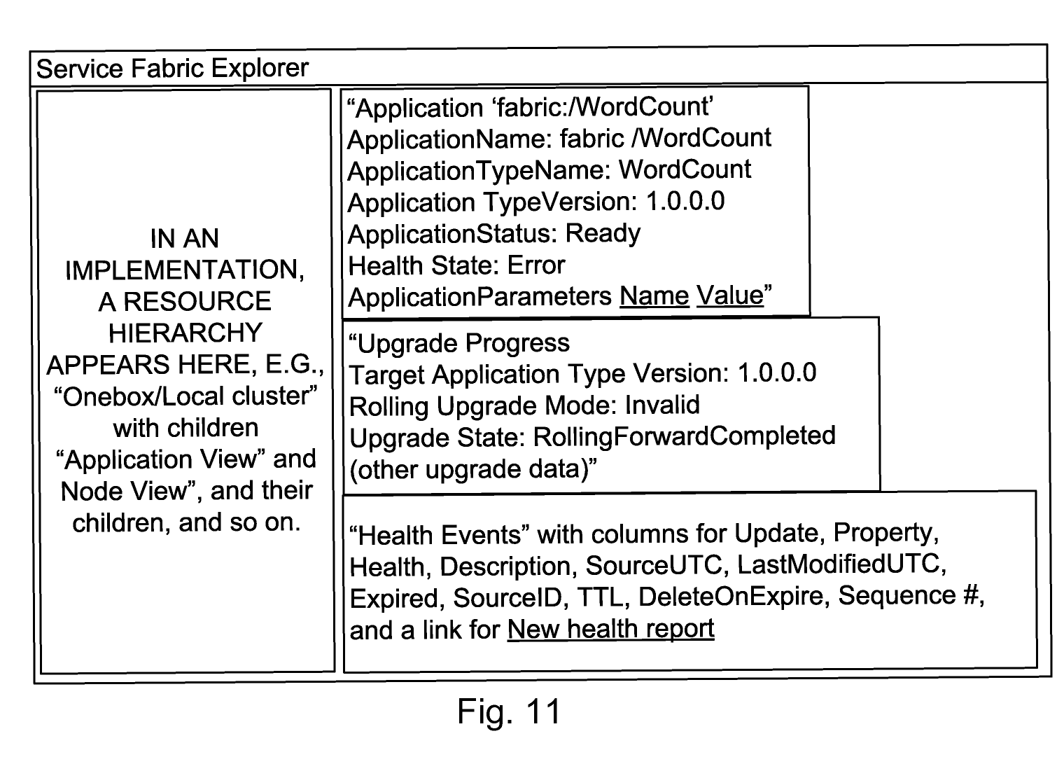

Service Fabric Explorer provides a visual view of the cluster. FIG. 11 shows one of the many possible interfaces for such tools. FIG. 11 is in black and white to comply with Patent Office regulations, but a given implementation could use colors, e.g., to represent health states. Thus, in one view a user might see that application fabric:/WordCount is red (at Error) because it has an error event reported by MyWatchdog for property Availability. The cluster is red because of the red application. One of its services, fabric:/WordCount/WordCount.Service may be depicted as yellow (at Warning) because of a System report. As described above, the service is configured with 7 replicas, which can't all be placed (since there are only 5 nodes in this example).

II(b). Health Queries

Service Fabric exposes health queries for each of the supported entity types, which can be accessed through an API (methods on FabricClient.HealthManager), PowerShell cmdlets and REST. These queries return complete health information about the entity, including aggregated health state, health events reported on the entity, children health states (when applicable) and unhealthy evaluations when the entity is not healthy.

A health entity is returned to the user when it is completely populated in the Health Store: the entity has a System report, it's active (not deleted) and parent entities on the hierarchy chain have System reports. If any of these conditions is not satisfied, the health queries return an exception showing why the entity is not returned.

The health queries pass in the entity identifier, which depends on the entity type. They accept optional health policy parameters. If not specified otherwise, the health policies from a cluster or application manifest are used for evaluation. They also accept filters for returning only partial children or events, the ones that respect the specified filters. In this implementation, the output filters are applied on the server side, so the message reply size is reduced. One can use the filters to limit the data returned rather than apply filters on the client side.

An entity health contains the following information:

The aggregated health state of the entity. This is computed by the Health Store based on entity health reports, children health states (when applicable) and health policies.
The health events on the entity.
For the entities that can have children, a collection of health states for all children.
The health states contain the entity identifier and the aggregated health state. To get complete health for a child, call the query health for the child entity type, passing in the child identifier.
If the entity is not healthy, the unhealthy evaluations which point to the report that triggered the state of the entity.

II(c). Get Cluster Health

Returns the health of the cluster entity. Contains the health states of applications and nodes (children of the cluster). Input: [optional] Application health policy map with health policies used to override the application manifest policies, [optional] Filter to return only events, nodes, applications with certain health state, e.g., return only errors, or warning or errors, etc.

II(D). API

Provided to let one get cluster health, create a FabricClient and call GetClusterHealthAsync method on its HealthManager.

The following gets cluster health: ClusterHealth clusterHealth=fabricClient.HealthManager.GetClusterHealthAsync( ). Result;
The following gets cluster health using custom cluster health policy and filters for nodes and applications. Note that it creates System.Fabric.Description.ClusterHealthQueryDescription that contains all the input data.

```
var policy = new ClusterHealthPolicy( )
{
  MaxPercentUnhealthyNodes = 20
};
var nodesFilter = new NodeHealthStatesFilter( )
{
  HealthStateFilter = (long)(HealthStateFilter.Error |
  HealthStateFilter.Warning)
};
var applicationsFilter = new ApplicationHealthStatesFilter( )
{
  HealthStateFilter = (long)HealthStateFilter.Error
};
var queryDescription = new ClusterHealthQueryDescription( )
{
  HealthPolicy = policy,
  ApplicationsFilter = applicationsFilter,
  NodesFilter = nodesFilter,
};
```

ClusterHealth clusterHealth=fabricClient.HealthManager.GetClusterHealthAsync(queryDescription). Result;

II(e). PowerShell

The cmdlet to get cluster health is Get-ServiceFabricClusterHealth. First connect to the cluster with Connect-ServiceFabricCluster cmdlet. State of the cluster: 5 nodes, System application and fabric:/WordCount configured as above.

The following cmdlet gets cluster health with default health policies. The aggregated health state is Warning, because the fabric:/WordCount application is in Warning. Note how the unhealthy evaluations show with details the condition that triggered the aggregated health.

PS C:\> Get-ServiceFabricClusterHealth
AggregatedHealthState : Warning
UnhealthyEvaluations :

Unhealthy applications: 50% (1/2),

MaxPercentUnhealthyApplications=0%.

Unhealthy application: ApplicationName=‘fabric:/WordCount’,

AggregatedHealthState=‘Warning’.

Unhealthy services: 100% (1/1),

ServiceType=‘WordCount.Service’, MaxPercentUnhealthyServices=0%.

Unhealthy service:

ServiceName=‘fabric:/WordCount/WordCount.Service’,
AggregatedHealthState=‘Warning’.

Unhealthy partitions: 100% (1/1),

MaxPercentUnhealthyPartitionsPerService=0%.

Unhealthy partition: PartitionId=‘889909a3-04d6-4a01-97c1-

3e9851d77d6c’, AggregatedHealthState=‘Warning’.

Unhealthy event: SourceId=‘System.FM’, Property=‘State’,

HealthState=‘Warning’, ConsiderWarningAsError=false.
NodeHealthStates :

| NodeName | : Node.4 |
|---|---|
| AggregatedHealthState : Ok | |
| NodeName | : Node.2 |
| AggregatedHealthState : Ok | |
| NodeName | : Node.1 |
| AggregatedHealthState : Ok | |
| NodeName | : Node.5 |
| AggregatedHealthState : Ok | |
| NodeName | : Node.3 |

AggregatedHealthState : Ok

ApplicationHealthStates :

| ApplicationName | : fabric:/CalculatorActor |
|---|---|
| AggregatedHealthState : Ok | |
| ApplicationName | : fabric:/System |
| AggregatedHealthState : Ok | |
| ApplicationName | : fabric:/WordCount |

AggregatedHealthState : Warning

HealthEvents : None

The following PowerShell cmdlet gets the health of the cluster with custom application policy. It filters results to get only Error or Warning applications and nodes. As a result, no nodes will be returned as they are all healthy. Only fabric:/WordCount application respects the applications filter. Because the custom policy specifies evaluation to consider warning as error for the fabric:/WordCount application, the application is evaluated at Error, and so is the cluster.

```
PS c:\> $appHealthPolicy = New-Object -TypeName
System.Fabric.Health.ApplicationHealthPolicy
$appHealthPolicy.ConsiderWarningAsError = $true
$appHealthPolicyMap = New-Object -TypeName
System.Fabric.Health.ApplicationHealthPolicyMap
$appUri1 = New-Object -TypeName System.Uri -ArgumentList
“fabric:/WordCount”
$appHealthPolicyMap.Add($appUri1, $appHealthPolicy)
$warningAndErrorFilter =
[System.Fabric.Health.HealthStateFilter]::Warning.value_ +
[System.Fabric.Health.HealthStateFilter]::Error.value_{—}
Get-ServiceFabricClusterHealth -ApplicationHealthPolicyMap
$appHealthPolicyMap -ApplicationsHealthStateFilter
$warningAndErrorFilter - NodesHealthStateFilter $warningAndErrorFilter
AggregatedHealthState  : Error
UnhealthyEvaluations  :
              Unhealthy applications: 50% (1/2),
MaxPercentUnhealthyApplications=0%.
              Unhealthy application: ApplicationName=
‘fabric:/WordCount’, AggregatedHealthState=‘Error’.
              Unhealthy services: 100% (1/1),
ServiceType=‘WordCount.Service’, MaxPercentUnhealthyServices=0%.
              Unhealthy service:
ServiceName=‘fabric:/WordCount/WordCount.Service’,
AggregatedHealthState=‘Error’.
              Unhealthy partitions: 100% (1/1),
MaxPercentUnhealthyPartitionsPerService=0%.
              Unhealthy partition: PartitionId=‘889909a3-04d6-
4a01-97c1-3e9851d77d6c’, AggregatedHealthState=‘Error’.
              Unhealthy event: SourceId=‘System.FM’,
Property=‘State’, HealthState=‘Warning’, ConsiderWarningAsError=true.
NodeHealthStates  : None
ApplicationHealthStates :
              ApplicationName  : fabric:/WordCount
              AggregatedHealthState : Error
HealthEvents  : None
```

II(f). Get Node Health

Returns the health of a node entity. Contains the health events reported on the node. Input: [required] The node name which identifies the node; [optional]Cluster health policy settings used to evaluate health; [optional] Filter to return only events with certain health state, e.g., return only errors.

II(G). API

To get node health through the API in this implementation, create a FabricClient and call GetNodeHealthAsync method on its HealthManager.

The following gets the node health for the specified node name. NodeHealth nodeHealth=fabricClient.HealthManager.GetNodeHealthAsync(nodeName).Result;
The following gets the node health for the specified node name, passing in events filter and custom policy through System.Fabric.Description.NodeHealthQueryDescription.

```
var queryDescription = new NodeHealthQueryDescription(nodeName)
{
  HealthPolicy = new ClusterHealthPolicy( ) {
  ConsiderWarningAsError = true }, EventsFilter = new
HealthEventsFilter( ) { HealthStateFilter = (long)HealthStateFilter.
Warning },
};
```

NodeHealth nodeHealth=fabricClient.HealthManager.GetNodeHealthAsync(queryDescription).Result;

II(h). PowerShell

The cmdlet to get node health is Get-ServiceFabricNodeHealth. First connect to the cluster with Connect-ServiceFabricCluster cmdlet. The following cmdlet gets node health with default health policies.

PS C:\> Get-ServiceFabricNodeHealth -NodeName Node.1
NodeName : Node.1
AggregatedHealthState : Ok
HealthEvents :

| | |
|---|---|
| SourceId | : System.FM |
| Property | : State |
| HealthState | : Ok |

| | |
|---|---|
| SequenceNumber | : 5 |

| | |
|---|---|
| SentAt | : 4/21/2015 8:01:17 AM |
| ReceivedAt | : 4/21/2015 8:02:12 AM |

| | |
|---|---|
| TTL | : Infinite |

| Description | : Fabric node is up. |
|---|---|
| RemoveWhenExpired : False | |
| IsExpired | : False |
| Transitions | : ->Ok = 4/21/2015 8:02:12 AM |

The following cmdlet gets the health of all nodes in the cluster.

PS C:\> Get-ServiceFabricNode | Get-ServiceFabricNodeHealth | select
NodeName, AggregatedHealthState | ft -AutoSize
NodeName AggregatedHealthState
-------- ---------------------

| | |
|---|---|
| Node.4 | Ok |
| Node.2 | Ok |
| Node.1 | Ok |
| Node.5 | Ok |
| Node.3 | Ok |

II(i). Get Application Health

Returns the health of an application entity. Contains the health states of deployed application and service children. Input: [required] Application name (URI) which identifies the application; [optional] Application health policy used to override the application manifest policies. [optional] Filter to return only events, services, deployed applications with certain health state.

II(j). API

To get application health, create a FabricClient and call GetApplicationHealthAsync method on its HealthManager.

The following gets the application health for the specified application name Uri. ApplicationHealth applicationHealth=fabricClient.HealthManager.GetApplicationHealthAsync(applicationName).Result;
The following gets the application health for the specified application name Uri, specifying filters and custom policy through System.Fabric.Description.ApplicationHealthQueryDescription. HealthStateFilter warningAndErrors=HealthStateFilter.Error|HealthStateFilter.Warning;

```
var serviceTypePolicy = new ServiceTypeHealthPolicy( )
{
  MaxPercentUnhealthyPartitionsPerService = 0,
  MaxPercentUnhealthyReplicasPerPartition = 5,
  MaxPercentUnhealthyServices = 0,
};
var policy = new ApplicationHealthPolicy( )
{
  ConsiderWarningAsError = false,
  DefaultServiceTypeHealthPolicy = serviceTypePolicy,
  MaxPercentUnhealthyDeployedApplications = 0,
};
var queryDescription = new
ApplicationHealthQueryDescription(applicationName)
{
  HealthPolicy = policy,
  EventsFilter = new HealthEventsFilter( ) { HealthStateFilter =
(long)warningAndErrors },
  ServicesFilter = new ServiceHealthStatesFilter( ) { HealthStateFilter =
(long)warningAndErrors },
  DeployedApplicationsFilter = new
DeployedApplicationHealthStatesFilter( ) {
HealthStateFilter = (long)warningAndErrors },
};
```

ApplicationHealth applicationHealth=fabricClient.HealthManager.GetApplicationHealthAsync(queryDescription).Result;

II(k). PowerShell

The cmdlet to get application health is Get-ServiceFabricApplicationHealth. First connect to the cluster with Connect-ServiceFabricCluster cmdlet.

The following cmdlet returns the health of the fabric:/WordCount application.

PS c:\> Get-ServiceFabricApplicationHealth fabric:/WordCount

| | |
|---|---|
| ApplicationName | : fabric:/WordCount |
| AggregatedHealthState | : Warning |
| UnhealthyEvaluations | : |

Unhealthy services: 100% (1/1),

ServiceType=‘WordCount.Service’,

MaxPercentUnhealthyServices=0%.
Unhealthy service:

ServiceName=‘fabric:/WordCount/WordCount.Service’,

AggregatedHealthState=‘Warning’.
Unhealthy partitions: 100% (1/1),

MaxPercentUnhealthyPartitionsPerService=0%.

Unhealthy partition: PartitionId=‘325da69f-16d4-4418-9c30-

1feaa40a072c’,

AggregatedHealthState=‘Warning’.
Unhealthy event: SourceId=‘System.FM’, Property=‘State’,

HealthState=‘Warning’,

ConsiderWarningAsError=false.

| | |
|---|---|
| ServiceHealthStates | : |

| | |
|---|---|
| ServiceName | : |

fabric:/WordCount/WordCount.WebService

| AggregatedHealthState : Ok | |
|---|---|
| ServiceName | : fabric:/WordCount/WordCount.Service |

AggregatedHealthState : Warning

DeployedApplicationHealthStates :

| ApplicationName | : fabric:/WordCount |
|---|---|
| NodeName | : Node.2 |
| AggregatedHealthState : Ok | |
| ApplicationName | : fabric:/WordCount |
| NodeName | : Node.5 |
| AggregatedHealthState : Ok | |
| ApplicationName | : fabric:/WordCount |
| NodeName | : Node.4 |
| AggregatedHealthState : Ok | |
| ApplicationName | : fabric:/WordCount |
| NodeName | : Node.1 |
| AggregatedHealthState : Ok | |
| ApplicationName | : fabric:/WordCount |
| NodeName | : Node.3 |

AggregatedHealthState : Ok

| | |
|---|---|
| HealthEvents | : |

| | |
|---|---|
| SourceId | : System.CM |
| Property | : State |
| HealthState | : Ok |

| | |
|---|---|
| SequenceNumber | : 2456 |

| SentAt | : 4/20/2015 9:57:06 PM |
|---|---|
| ReceivedAt | : 4/20/2015 9:57:06 PM |
| TTL | : Infinite |
| Description | : Application has been created. |
| RemoveWhenExpired : False | |
| IsExpired | : False |
| Transitions | : ->Ok = 4/20/2015 9:57:06 PM |

The following PowerShell command passes in custom policy and filters children and events.

PS C:\> $errorFilter = [System.Fabric.Health.HealthStateFilter]::Error.value_{—}
Get-ServiceFabricApplicationHealth -ApplicationName fabric:/WordCount -
ConsiderWarningAsError $true -ServicesHealthStateFilter $errorFilter -
EventsHealthStateFilter $errorFilter -DeployedApplicationsHealthStateFilter
$errorFilter

| | |
|---|---|
| ApplicationName | : fabric:/WordCount |
| AggregatedHealthState | : Error |
| UnhealthyEvaluations | : |

```
                  Unhealthy services: 100% (1/1),
ServiceType=‘WordCount.Service’, MaxPercentUnhealthyServices=0%.
                  Unhealthy service:
ServiceName=‘fabric:/WordCount/WordCount.Service’,
AggregatedHealthState=‘Error’.
                  Unhealthy partitions: 100% (1/1),
MaxPercentUnhealthyPartitionsPerService=0%.
                  Unhealthy partition: PartitionId=‘8f82daff-eb68-4fd9-b631-
7a37629e08c0’, AggregatedHealthState=‘Error’.
                  Unhealthy event: SourceId=‘System.FM’, Property=‘State’,
HealthState=‘Warning’, ConsiderWarningAsError=true.
ServiceHealthStates  :
                  ServiceName  : fabric:/WordCount/WordCount.Service
                  AggregatedHealthState : Error
DeployedApplicationHealthStates : None
```

| | |
|---|---|
| HealthEvents | : None |

II(l). Get Service Health

Returns the health of a service entity. Contains the partition health states. Input: [required] Service name (URI) which identifies the service; [optional]Application health policy used to override the application manifest policy; [optional] Filter to return only events and partitions with certain health state.

II(m). API

To get service health through API, create a FabricClient and call GetServiceHealthAsync method on its HealthManager.

The following example get the health of a service with specified service name (URI):
ServiceHealth serviceHealth=fabricClient.HealthManager.GetServiceHealthAsync(serviceName).Result;
The following gets the service health for the specified service name URI, specifying filters and custom policy through System.Fabric.Description.ServiceHealthQueryDescription. var queryDescription=new ServiceHealthQueryDescription(serviceName)

```
{
  EventsFilter = new HealthEventsFilter( ) { HealthStateFilter =
(long)HealthStateFilter.All },
  PartitionsFilter = new PartitionHealthStatesFilter( ) {
HealthStateFilter = (long)HealthStateFilter.Error },
};
```

ServiceHealth serviceHealth=fabricClient.HealthManager.GetServiceHealthAsync(queryDescription).Result;

II(m). PowerShell

The cmdlet to get service health is Get-ServiceFabricServiceHealth. First connect to the cluster with Connect-ServiceFabricCluster cmdlet.

The following cmdlet gets the service health using default health policies.

PS C:\> Get-ServiceFabricServiceHealth -ServiceName
fabric:/WordCount/WordCount.Service

| | |
|---|---|
| ServiceName | : fabric:/WordCount/WordCount.Service |

AggregatedHealthState : Warning
UnhealthyEvaluations :

Unhealthy partitions: 100% (1/1),

MaxPercentUnhealthyPartitionsPerService=0%.

Unhealthy partition: PartitionId=‘8f82daff-eb68-4fd9-b631-

7a37629e08c0’, AggregatedHealthState=‘Warning’.

Unhealthy event: SourceId=‘System.FM’, Property=‘State’,

HealthState=‘Warning’, ConsiderWarningAsError=false.
PartitionHealthStates :

| | |
|---|---|
| PartitionId | : 8f82daff-eb68-4fd9-b631-7a37629e08c0 |

AggregatedHealthState : Warning

| | |
|---|---|
| HealthEvents | : |

| | |
|---|---|
| SourceId | : System.FM |
| Property | : State |
| HealthState | : Ok |

| | |
|---|---|
| SequenceNumber | : 3 |

| | |
|---|---|
| SentAt | : 4/20/2015 10:12:29 PM |
| ReceivedAt | : 4/20/2015 10:12:33 PM |
| TTL | : Infinite |
| Description | : Service has been created. |

| | |
|---|---|
| RemoveWhenExpired | : False |

| | |
|---|---|
| IsExpired | : False |
| Transitions | : −>Ok = 4/20/2015 10:12:33 PM |

II(n). Get Partition Health

Returns the health of a partition entity. Contains the replica health states. Input: [required] Partition id (Guid) which identifies the partition; [optional]Application health policy used to override the application manifest policy; [optional] Filter to return only events, replicas with certain health state.

II(o). API

To get partition health through API, create a FabricClient and call GetPartitionHealthAsync method on its HealthManager. To specify optional parameters, create System.Fabric.Description.PartitionHealthQueryDescription. PartitionHealth partitionHealth=fabricClient.HealthManager.GetPartitionHealthAsync(partitionId).Result;

II(p). PowerShell

The cmdlet to get partition health is Get-ServiceFabricPartitionHealth. First connect to the cluster with Connect-ServiceFabricCluster cmdlet.

The following cmdlet gets the health for all partitions of the word count service.

PS C:\> Get-ServiceFabricPartition
fabric:/WordCount/WordCount.Service | Get-
ServiceFabricPartitionHealth

| | |
|---|---|
| Partition Id | : 8f82daff-eb68-4fd9-b631-7a37629e08c0 |

AggregatedHealthState : Warning
UnhealthyEvaluations :

Unhealthy event: SourceId=‘System.FM’,

Property=‘State’, HealthState=‘Warning’, ConsiderWarningAsError=false.
ReplicaHealthStates :

| ReplicaId | : 130740415594605870 |
|---|---|
| AggregatedHealthState : Ok | |
| ReplicaId | : 130740415502123433 |
| AggregatedHealthState : Ok | |
| ReplicaId | : 130740415594605867 |
| AggregatedHealthState : Ok | |
| ReplicaId | : 130740415594605869 |
| AggregatedHealthState : Ok | |
| ReplicaId | : 130740415594605868 |

AggregatedHealthState : Ok

| | |
|---|---|
| HealthEvents | : |

| | |
|---|---|
| SourceId | : System.FM |
| Property | : State |

| | |
|---|---|
| HealthState | : Warning |

| | |
|---|---|
| SequenceNumber | : 39 |

| | |
|---|---|
| SentAt | : 4/20/2015 10:12:59 PM |

| | |
|---|---|
| ReceivedAt | : 4/20/2015 10:13:03 PM |

| | |
|---|---|
| TTL | : Infinite |
| Description | : Partition is below target replica or |

instance count.

| | |
|---|---|
| RemoveWhenExpired | : False |

| | |
|---|---|
| IsExpired | : False |
| Transitions | : Ok−>Warning = 4/20/2015 10:13:03 PM |

II(q). Get Replica Health

Returns the health of a replica. Input: [required] Partition id (Guid) and replica id which identify the replica; [optional] Application health policy parameters used to override the application manifest policies; [optional] Filter to return only events with certain health state.

II(r). API

To get replica health through API, create a FabricClient and call GetReplicaHealthAsync method on its HealthManager. Specify advanced parameters with System.Fabric.Description.ReplicaHealthQueryDescription.

ReplicaHealth replicaHealth=fabricClient.HealthManager.GetReplicaHealthAsync(partitionId, replicaId).Result;

II(s). PowerShell

The cmdlet to get replica health is Get-ServiceFabricReplicaHealth. First connect to the cluster with Connect-ServiceFabricCluster cmdlet.

The following cmdlet gets the health of the primary replica for all partitions of the service.

PS C:\> Get-ServiceFabricPartition
fabric:/WordCount/WordCount.Service | Get-
ServiceFabricReplica | where {$_.ReplicaRole -eq
“Primary”} | Get-
ServiceFabricReplicaHealth

| PartitionId | : 8f82daff-eb68-4fd9-b631-7a37629e08c0 |
|---|---|
| ReplicaId | : 130740415502123433 |

AggregatedHealthState : Ok

| | |
|---|---|
| HealthEvents | : |

| | |
|---|---|
| SourceId | : System.RA |
| Property | : State |
| HealthState | : Ok |

| | |
|---|---|
| SequenceNumber | : 130740415502802942 |

| | |
|---|---|
| SentAt | : 4/20/2015 10:12:30 PM |
| ReceivedAt | : 4/20/2015 10:12:34 PM |
| TTL | : Infinite |
| Description | : Replica has been created. |

| | |
|---|---|
| RemoveWhenExpired | : False |

| | |
|---|---|
| IsExpired | : False |
| Transitions | : −>Ok = 4/20/2015 10:12:34 PM |

II(s). Get Deployed Application Health

Returns the health of an application deployed on a node entity. Contains the deployed service package health states. Input: [required]Application name (URI) and node name (string) which identify the deployed application; [optional] Application health policy used to override the application manifest policies; [optional] Filter to return only events, deployed service packages with certain health state.

II(t). API

To get the health on an application deployed on a node through API, create a FabricClient and call GetDeployedApplicationHealthAsync method on its HealthManager. To specify optional parameters, use System.Fabric.Description.DeployedApplicationHealthQueryDescription.

DeployedApplicationHealth health=fabricClient.HealthManager.GetDeployedApplicationHealthAsync(new DeployedApplicationHealthQueryDescription(applicationName, nodeName)).Result;

II(u). PowerShell

The cmdlet to get deployed application health is Get-ServiceFabricDeployedApplicationHealth. First connect to the cluster with Connect-ServiceFabricCluster cmdlet. To find out where an application is deployed, run Get-ServiceFabricApplicationHealth and look at the deployed application children.

The following cmdlter gets the health of the fabric:/WordCount application deployed on node Node.1.

PS C:\> Get-ServiceFabricDeployedApplicationHealth -ApplicationName
fabric:/WordCount -NodeName Node.1

| | |
|---|---|
| ApplicationName | : fabric:/WordCount |
| NodeName | : Node.1 |

| | |
|---|---|
| AggregatedHealthState | : Ok |

DeployedServicePackageHealthStates :

| ServiceManifestName : WordCount.WebService | |
|---|---|
| NodeName | : Node.1 |
| AggregatedHealthState : Ok | |
| ServiceManifestName : WordCount.Service | |
| NodeName | : Node.1 |

AggregatedHealthState : Ok

| | |
|---|---|
| HealthEvents | : |

| | |
|---|---|
| SourceId | : System.Hosting |
| Property | : Activation |
| HealthState | :Ok |

| | |
|---|---|
| SequenceNumber | : 130740415502842941 |

| | |
|---|---|
| SentAt | : 4/20/2015 10:12:30 PM |
| ReceivedAt | : 4/20/2015 10:12:34 PM |
| TTL | : Infinite |
| Description | : The application was activated |

successfully.

| | |
|---|---|
| RemoveWhenExpired | : False |

| | |
|---|---|
| IsExpired | : False |
| Transitions | : −>Ok = 4/20/2015 10:12:34 PM |

II(v). Get deployed service package health

Returns the health of a deployed service package entity. Input: [required] Application name (URI), node name (string) and service manifest name (string) which identify the deployed service package; [optional] Application health policy used to override the application manifest policy; [optional] Filter to return only events with certain health state.

II(w). API

To get the health of a deployed service package through API, create a FabricClient and call GetDeployedServicePackageHealthAsync method on its Health Manager.

DeployedServicePackageHealth health=fabricClient.HealthManager.GetDeployedServicePackageHealthAsync(new DeployedServicePackageHealthQueryDescription(applicationName, nodeName, serviceManifestName)).Result;

II(x). PowerShell

The cmdlet to get deployed service package health is Get-ServiceFabricDeployedServicePackageHealth. First connect to the cluster with Connect-ServiceFabricCluster cmdlet. To see where an application is deployed, run Get-ServiceFabricApplicationHealth, look at deployed applications. To see what service packages are in an application, look at the deployed service package children in Get-ServiceFabricDeployedApplicationHealth output.

The following cmdlet gets the health of the WordCount.Service service package of the fabric:/WordCount application deployed on node Node.1. The entity has System.Hosting reports for successful service package and entry point activation and successful service type registration.

PS C:\> Get-ServiceFabricDeployedApplication -ApplicationName
fabric:/WordCount -NodeName Node.1 | Get-
ServiceFabricDeployedServicePackageHealth -ServiceManifestName
WordCount.Service

| | |
|---|---|
| ApplicationName | : fabric:/WordCount |

ServiceManifestName : WordCount.Service

| | |
|---|---|
| NodeName | : Node.1 |

AggregatedHealthState : Ok

| HealthEvents | : | |
|---|---|---|
| | SourceId | : System.Hosting |
| | Property | : Activation |
| | HealthState | : Ok |

| | |
|---|---|
| SequenceNumber | : 130740415506383060 |

| | |
|---|---|
| SentAt | : 4/20/2015 10:12:30 PM |
| ReceivedAt | : 4/20/2015 10:12:34 PM |
| TTL | : Infinite |
| Description | : The ServicePackage was activated |

successfully.

| | |
|---|---|
| RemoveWhenExpired | : False |

| | |
|---|---|
| IsExpired | : False |
| Transitions | : −>Ok = 4/20/2015 10:12:34 PM |
| SourceId | : System.Hosting |
| Property | : CodePackageActivation:Code:EntryPoint |
| HealthState | : Ok |

| | |
|---|---|
| SequenceNumber | : 130740415506543054 |

| | |
|---|---|
| SentAt | : 4/20/2015 10:12:30 PM |
| ReceivedAt | : 4/20/2015 10:12:34 PM |
| TTL | : Infinite |
| Description | : The CodePackage was activated successfully. |

| | |
|---|---|
| RemoveWhenExpired | : False |

| | |
|---|---|
| IsExpired | : False |
| Transitions | : −>Ok = 4/20/2015 10:12:34 PM |
| SourceId | : System.Hosting |
| Property | : ServiceTypeRegistration:WordCount.Service |
| HealthState | : Ok |

| | |
|---|---|
| SequenceNumber | : 130740415520193499 |

| | |
|---|---|
| SentAt | : 4/20/2015 10:12:32 PM |
| ReceivedAt | : 4/20/2015 10:12:34 PM |
| TTL | : Infinite |
| Description | : The ServiceType was registered successfully. |

| | |
|---|---|
| RemoveWhenExpired | : False |

| | |
|---|---|
| IsExpired | : False |
| Transitions | : −>Ok = 4/20/2015 10:12:34 PM |

II(y). General Queries

The general queries return the list of Service Fabric entities of the specified type. They are exposed through API (methods on FabricClient.QueryManager), PowerShell cmdlets and REST. These queries aggregate sub-queries from multiple components. One of them is the Health Store, which populates the aggregated health state for each query result. In this implementation, the general queries return the aggregated health state of the entity and do not contain the rich health data. If an entity is not healthy, one can follow up with health queries to get all health information, like events, children health states and unhealthy evaluations.

If the general queries return Unknown health state for an entity, it's possible that the Health Store doesn't have complete data about the entity or the sub-query to the Health Store wasn't successful (eg. communication error, health store was throttled etc). Follow up with a health query for the entity. This may succeed, if the sub-query encountered transient errors (eg. network issues), or will give more details about why the entity is not exposed from Health store.

The queries that contain HealthState for entities are:

Node list. Returns the list nodes in the cluster.

Api: FabricClient.QueryManager.GetNodeListAsync.

PowerShell: Get-ServiceFabricNode.

Application list. Returns the list of applications in the cluster.

Api: FabricClient.QueryManager.GetApplicationListAsync.

PowerShell: Get-ServiceFabricApplication.

Service list. Returns the list of services in an application.

Api: FabricClient.QueryManager.GetServiceListAsync.

PowerShell: Get-ServiceFabricService.

Partition list. Returns the list of partitions in a service.

Api: FabricClient.QueryManager.GetPartitionListAsync.

PowerShell: Get-ServiceFabricPartition.

Replica list. Returns the list of replicas in a partition.

Api: FabricClient.QueryManager.GetReplicaListAsync.

PowerShell: Get-ServiceFabricReplica.

Deployed application list. Returns the list of deployed applications on a node.

Api: FabricClient.QueryManager.GetDeployedApplicationListAsync.

PowerShell: Get-ServiceFabricDeployedApplication.

Deployed service package list. Returns the list of service packages in a deployed application.

Api: FabricClient.QueryManager.GetDeployedServicePackageListAsync.

PowerShell: Get-ServiceFabricDeployedApplication.

II(z). Examples

The following gets the unhealthy applications in the cluster:

var applications=fabricClient.QueryManager.GetApplicationListAsync( ).Result.Where(app=>app.HealthState==HealthState.Error);

The following cmdlet gets application details for fabric:/WordCount application. Notice that health state is Warning.

PS C:\> Get-ServiceFabricApplication -ApplicationName fabric:/WordCount

| | |
|---|---|
| ApplicationName | : fabric:/WordCount |

ApplicationTypeName : WordCount
ApplicationTypeVersion : 1.0.0.0

| | |
|---|---|
| ApplicationStatus | : Ready |
| HealthState | : Warning |

ApplicationParameters : { “_WFDebugParams_” =
“[{“ServiceManifestName”:“WordCount.WebService”,“CodePackageName”:“Cod
e”,“EntryPointType”:“Main”}]”}

The following cmdlet gets the services with health state Warning.

PS C:\> Get-ServiceFabricApplication | Get-ServiceFabricService | where
{$_.HealthState -eq “Warning”}

| | |
|---|---|
| ServiceName | : fabric:/WordCount/WordCount.Service |
| ServiceKind | : Stateful |

| | |
|---|---|
| ServiceTypeName | : WordCount.Service |

| | |
|---|---|
| IsServiceGroup | : False |

ServiceManifestVersion : 1.0

| | |
|---|---|
| HasPersistedState | : True |
| ServiceStatus | : Active |
| HealthState | : Warning |

II(aa). Cluster and Application Upgrade

During cluster and application monitored upgrade, Service Fabric checks health to ensure everything is and remains healthy. If something is unhealthy per configured policy, the upgrade is either paused to allow user interaction or automatically rolled back.

During cluster upgrade, using this implementation one can get the cluster upgrade status, which will include unhealthy evaluations that point to what is unhealthy in the cluster. If the upgrade is rolled back due to health issues, the upgrade status will keep the last unhealthy reasons so administrators can investigate what went wrong. Similarly, during application upgrade, the application upgrade status contains the unhealthy evaluations.

The following shows the application upgrade status for a modified fabric:/WordCount application. A watchdog reported an Error on one of its replica. The upgrade is rolling back because the health checks are not respected.

PS C:\> Get-ServiceFabricApplicationUpgrade fabric:/WordCount

| | |
|---|---|
| ApplicationName | : fabric:/WordCount |
| ApplicationTypeName | : WordCount |

TargetApplicationTypeVersion : 1.0.0.0

| | |
|---|---|
| ApplicationParameters | : { } |
| StartTimestampUtc | : 4/21/2015 5:23:26 PM |
| FailureTimestampUtc | : 4/21/2015 5:23:37 PM |
| FailureReason | : HealthCheck |
| UpgradeState | : RollingBackInProgress |
| UpgradeDuration | : 00:00:23 |

CurrentUpgradeDomainDuration : 00:00:00
CurrentUpgradeDomainProgress : UD1

| | |
|---|---|
| NodeName | : Node1 |
| UpgradePhase | : Upgrading |
| NodeName | : Node2 |
| UpgradePhase | : Upgrading |
| NodeName | : Node3 |
| UpgradePhase | : PreUpgradeSafetyCheck |

PendingSafetyChecks :
EnsurePartitionQuorum - PartitionId: 30db5be6-4e20-4698-

8185-4bd7ca744020

| | |
|---|---|
| NextUpgradeDomain | : UD2 |
| UpgradeDomainsStatus | : { “UD1” = “Completed”; |
| | “UD2” = “Pending”; |
| | “UD3” = “Pending”; |
| | “UD4” = “Pending” } |
| UnhealthyEvaluations | : |
| | Unhealthy services: 100% (1/1), |

ServiceType=‘WordCount.Service’, MaxPercentUnhealthyServices=0%.

Unhealthy service:

ServiceName=‘fabric:/WordCount/WordCount.Service’,
AggregatedHealthState=‘Error’.

Unhealthy partitions: 100% (1/1),

MaxPercentUnhealthyPartitionsPerService=0%.

Unhealthy partition: PartitionId=‘30db5be6-4e20-4698-8185-

4bd7ca744020’, AggregatedHealthState=“Error’.

Unhealthy replicas: 16% (1/6),

MaxPercentUnhealthyReplicasPerPartition=0%.

Unhealthy replica: Partition Id-‘30db5be6-4e20-4698-8185-

4bd7ca744020’, ReplicaOrInstanceId=‘130741105362491906’,
AggregatedHealthState=‘Error’.

| | |
|---|---|
| | Error event: SourceId=‘DiskWatcher’, Property=‘Disk’. |
| UpgradeKind | : Rolling |
| RollingUpgradeMode | : UnmonitoredAuto |
| ForceRestart | : False |

UpgradeReplicaSetCheckTimeout : 00:15:00

II(Bb). Troubleshoot with Health

Whenever there is an issue in the cluster or an application, look at the cluster or the application health to pinpoint what is wrong. The unhealthy evaluations will show with details what triggered the current unhealthy state. If needed, drill down into unhealthy children entities to figure out issues.

The System health reports provide visibility into cluster and application functionality and flag issues through health. For application and services, the System health reports verify that entities are implemented and are behaving correctly from Service Fabric perspective. The reports do not provide any health monitoring of the business logic of the service or detection of hung processes. User services can enrich the health data with information specific to their logic.

Watchdogs' health reports are only visible after the system components create an entity. When an entity is deleted, the Health Store automatically deletes all health reports associated with it. Same when a new instance of the entity is created (eg. a new service replica instance is created): all reports associated with the old instance are deleted and cleaned up from store.

The System components reports are identified by the source, which starts with “System.” prefix. Watchdogs can't use the same prefix for their sources, as reports will be rejected with invalid parameters.

Some example system reports are shown below.

The following shows the System.FM event with health state Ok for node up:

PS C:\> Get-ServiceFabricNodeHealth -NodeName Node.1

| | |
|---|---|
| NodeName | : Node.1 |

AggregatedHealthState : Ok

| HealthEvents | : | |
|---|---|---|
| | SourceId | : System.FM |
| | Property | : State |
| | HealthState | : Ok |

| | |
|---|---|
| SequenceNumber | : 2 |

| | |
|---|---|
| SentAt | : 4/24/2015 5:27:33 PM |
| ReceivedAt | : 4/24/2015 5:28:50 PM |
| TTL | : Infinite |
| Description | : Fabric node is up. |

| | |
|---|---|
| RemoveWhenExpired | : False |

| | |
|---|---|
| IsExpired | : False |
| Transitions | : −>Ok = 4/24/2015 5:28:50 PM |

The following shows the State event (Ok when the application is created or updated) on fabric:/WordCount application.

PS C:\> Get-ServiceFabricApplicationHealth fabric:/WordCount -
ServicesHealthStateFilter
([System.Fabric.Health.HealthStateFilter]::None) -
DeployedApplicationsHealthStateFilter
([System.Fabric.Health.HealthStateFilter]::None)

| | |
|---|---|
| ApplicationName | : fabric:/WordCount |
| AggregatedHealthState | : Ok |
| ServiceHealthStates | : None |

DeployedApplicationHealthStates : None

| HealthEvents | : | |
|---|---|---|
| | SourceId | : System.CM |
| | Property | : State |
| | HealthState | : Ok |

| | |
|---|---|
| SequenceNumber | : 82 |

| | |
|---|---|
| SentAt | : 4/24/2015 6:12:51 PM |
| ReceivedAt | : 4/24/2015 6:12:51 PM |
| TTL | : Infinite |
| Description | : Application has been created. |

| | |
|---|---|
| RemoveWhenExpired | : False |

| | |
|---|---|
| IsExpired | : False |
| Transitions | : −>Ok = 4/24/2015 6:12:51 PM |

The following shows a healthy partition.

PS C:\> Get-ServiceFabricPartition
fabric:/StatelessPiApplication/StatelessPiService | Get-
ServiceFabricPartitionHealth

| | |
|---|---|
| Partition Id | : 29da484c-2c08-40c5-b5d9-03774af9a9bf |

AggregatedHealthState : Ok
ReplicaHealthStates : None

| | |
|---|---|
| HealthEvents | : |

| | |
|---|---|
| SourceId | : System.FM |
| Property | : State |
| HealthState | : Ok |

| | |
|---|---|
| SequenceNumber | : 38 |

| | |
|---|---|
| SentAt | : 4/24/2015 6:33:10 PM |
| ReceivedAt | : 4/24/2015 6:33:31 PM |
| TTL | : Infinite |
| Description | : Partition is healthy. |

| | |
|---|---|
| RemoveWhenExpired | : False |

| | |
|---|---|
| IsExpired | : False |
| Transitions | : −>Ok = 4/24/2015 6:33:31 PM |

The following shows the health of a partition that is below target replica count. Next steps: get the partition description, which shows how it was configured: MinReplicaSetSize is 2, TargetReplicaSetSize is 7. Then get the number of nodes in the cluster: 5. So in this case, 2 replicas can't be placed.

PS C:\> Get-ServiceFabricPartition
fabric:/WordCount/WordCountService | Get-
ServiceFabricPartitionHealth -ReplicasHealthStateFilter
([System.Fabric.Health.HealthStateFilter]::None)

| | |
|---|---|
| PartitionId | : 875a1caa-d79f-43bd-ac9d-43ee89a9891c |

AggregatedHealthState : Warning
UnhealthyEvaluations :

Unhealthy event: SourceId=‘System.FM’, Property=‘State’,

HealthState=‘Warning’, ConsiderWarningAsError=false.
ReplicaHealthStates : None

| | |
|---|---|
| HealthEvents | : |

| | |
|---|---|
| SourceId | : System.FM |
| Property | : State |
| HealthState | : Warning |

| | |
|---|---|
| SequenceNumber | : 37 |

| | |
|---|---|
| SentAt | : 4/24/2015 6:13:12 PM |
| ReceivedAt | : 4/24/2015 6:13:31 PM |
| TTL | : Infinite |
| Description | : Partition is below target replica or instance |

count.

| | |
|---|---|
| RemoveWhenExpired | : False |

| | |
|---|---|
| IsExpired | : False |
| Transitions | : Ok−>Warning = 4/24/2015 6:13:31 PM |

PS C:\> Get-ServiceFabricPartition fabric:/WordCount/WordCountService

| | |
|---|---|
| PartitionId | : 875a1caa-d79f-43bd-ac9d-43ee89a9891c |
| PartitionKind | : Int64Range |

| | |
|---|---|
| PartitionLowKey | : 1 |
| PartitionHighKey | : 26 |

| | |
|---|---|
| PartitionStatus | : Ready |

LastQuorumLossDuration : 00:00:00

| | |
|---|---|
| MinReplicaSetSize | : 2 |

| | |
|---|---|
| TargetReplicaSetSize | : 7 |

| | |
|---|---|
| HealthState | : Warning |

| | |
|---|---|
| DataLossNumber | : 130743727710830900 |

ConfigurationNumber : 8589934592
PS C:\> @(Get-ServiceFabricNode).Count
5

The following shows a healthy replica:

PS C:\> Get-ServiceFabricPartition
fabric:/WordCount/WordCountService | Get-
ServiceFabricReplica | where {$_.ReplicaRole -eq “Primary”} | Get-
ServiceFabricReplicaHealth

| PartitionId | : 875a1caa-d79f-43bd-ac9d-43ee89a9891c |
|---|---|
| ReplicaId | : 130743727717237310 |

AggregatedHealthState : Ok

| | |
|---|---|
| HealthEvents | : |

| | |
|---|---|
| SourceId | : System.RA |
| Property | : State |
| HealthState | : Ok |

| | |
|---|---|
| SequenceNumber | : 130743727718018580 |

| | |
|---|---|
| SentAt | : 4/24/2015 6:12:51 PM |
| ReceivedAt | : 4/24/2015 6:13:02 PM |
| TTL | : Infinite |
| Description | : Replica has been created. |

| | |
|---|---|
| RemoveWhenExpired | : False |

| | |
|---|---|
| IsExpired | : False |
| Transitions | : −>Ok = 4/24/2015 6:13:02 PM |

The following example shows a partition in quorum loss and investigation steps done to figure out why. One of the replicas has Warning health state, so the developer gets its health, which indicates that service operation takes longer than expected, event reported by System.RAP. After this information, a next step is to look at service code and investigate. For this case, the RunAsync implementation of the stateful service throws an unhandled exception. Note that replicas are recycling, so one might not see any replicas in Warning state. Retry getting the health and look whether there are any differences in replica id, this gives clues in certain cases.

PS C:\> Get-ServiceFabricPartition
fabric:/HelloWorldStatefulApplication/HelloWorldStateful | Get-
ServiceFabricPartitionHealth

| | |
|---|---|
| PartitionId | : 72a0fb3e-53ec-44f2-9983-2f272aca3e38 |

AggregatedHealthState : Error
UnhealthyEvaluations :

Error event: SourceId=‘System.FM’, Property=‘State’.

ReplicaHealthStates :

| ReplicaId | : 130743748372546446 |
|---|---|
| AggregatedHealthState : Ok | |
| ReplicaId | : 130743746168084332 |
| AggregatedHealthState : Ok | |
| ReplicaId | : 130743746195428808 |
| AggregatedHealthState : Warning | |
| ReplicaId | : 130743746195428807 |

AggregatedHealthState : Ok

| | |
|---|---|
| HealthEvents | : |

| | |
|---|---|
| SourceId | : System.FM |
| Property | : State |
| HealthState | : Error |

| | |
|---|---|
| SequenceNumber | : 182 |

| | |
|---|---|
| SentAt | : 4/24/2015 7:00:17 PM |
| ReceivedAt | : 4/24/2015 7:00:31 PM |
| TTL | : Infinite |
| Description | : Partition is in quorum loss. |

| | |
|---|---|
| RemoveWhenExpired | : False |

| | |
|---|---|
| IsExpired | : False |
| Transitions | : Warning−>Error = 4/24/2015 6:51:31 PM |

PS C:\> Get-ServiceFabricPartition
fabric:/HelloWorldStatefulApplication/HelloWorldStateful

| | |
|---|---|
| PartitionId | : 72a0fb3e-53ec-44f2-9983-2f272aca3e38 |

| | |
|---|---|
| PartitionKind | : Int64Range |

| | |
|---|---|
| PartitionLowKey | : −9223372036854775808 |
| PartitionHighKey | : 9223372036854775807 |

| | |
|---|---|
| PartitionStatus | : InQuorumLoss |

LastQuorumLossDuration : 00:00:13

| | |
|---|---|
| MinReplicaSetSize | : 2 |

| | |
|---|---|
| TargetReplicaSetSize | : 3 |

| | |
|---|---|
| HealthState | : Error |

DataLossNumber : 130743746152927699
ConfigurationNumber : 227633266688
PS C:\> Get-ServiceFabricReplica
72a0fb3e-53ec-44f2-9983-2f272aca3e38
130743746195428808

| | |
|---|---|
| ReplicaId | : 130743746195428808 |

| | |
|---|---|
| ReplicaAddress | : PartitionId: |
| | 72a0fb3e-53ec-44f2-9983-2f272aca3e38, |

ReplicaId: 130743746195428808

| | |
|---|---|
| ReplicaRole | : Primary |

| | |
|---|---|
| NodeName | : Node.3 |

| | |
|---|---|
| ReplicaStatus | : Ready |

LastInBuildDuration : 00:00:01

| | |
|---|---|
| HealthState | : Warning |

PS C:\> Get-ServiceFabricReplicaHealth 72a0fb3e-53ec-44f2-9983-
2f272aca3e38 130743746195428808

| | |
|---|---|
| Partition Id | : 72a0fb3e-53ec-44f2-9983-2f272aca3e38 |
| ReplicaId | : 130743746195428808 |

AggregatedHealthState : Warning
UnhealthyEvaluations :

Unhealthy event: SourceId=‘System.RAP’,

Property=‘ServiceOpenOperationDuration’, HealthState=‘Warning’,
ConsiderWarningAsError=false.

| | |
|---|---|
| HealthEvents | : |

| | |
|---|---|
| SourceId | : System.RA |
| Property | : State |
| HealthState | : Ok |

| | |
|---|---|
| SequenceNumber | : 130743756170185892 |

| | |
|---|---|
| SentAt | : 4/24/2015 7:00:17 PM |
| ReceivedAt | : 4/24/2015 7:00:33 PM |
| TTL | : Infinite |
| Description | : Replica has been created. |

| | |
|---|---|
| RemoveWhenExpired | : False |

| | |
|---|---|
| IsExpired | : False |
| Transitions | : −>Ok = 4/24/2015 7:00:33 PM |
| SourceId | : System.RAP |
| Property | : ServiceOpenOperationDuration |
| HealthState | : Warning |

| | |
|---|---|
| SequenceNumber | : 130743756399407044 |

| | |
|---|---|
| SentAt | : 4/24/2015 7:00:39 PM |
| ReceivedAt | : 4/24/2015 7:00:59 PM |
| TTL | : Infinite |
| Description | : Start Time (UTC): 2015-04-24 19:00:17.019 |

| | |
|---|---|
| RemoveWhenExpired | : False |

| | |
|---|---|
| IsExpired | : False |
| Transitions | : −>Warning = 4/24/2015 7:00:59 PM |

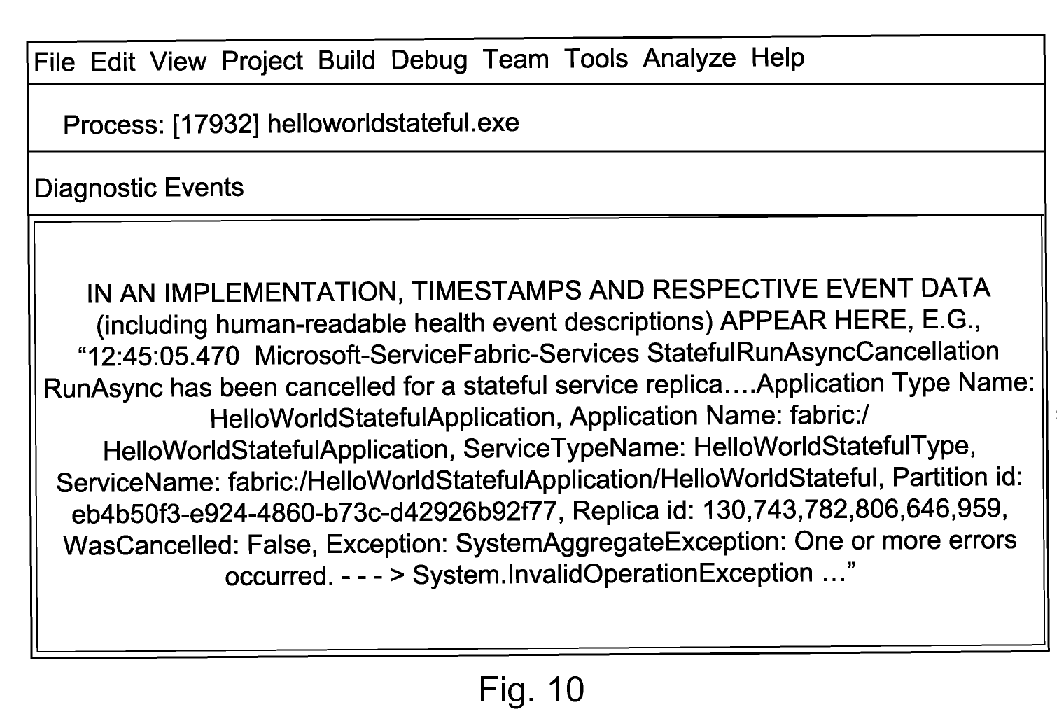

When starting the faulty application under debugger, in some tools Diagnostic Events windows show the exception thrown from RunAsync, as illustrated in FIG. 10.

The following report 212 shows a healthy deployed service package.

PS C:\> Get-ServiceFabricDeployedServicePackageHealth
-NodeName Node.1 -
ApplicationName fabric:/WordCount -ServiceManifestName
WordCountServicePkg

| | |
|---|---|
| ApplicationName | : fabric:/WordCount |

ServiceManifestName : WordCountServicePkg

| | |
|---|---|
| NodeName | : Node.1 |

AggregatedHealthState : Ok

| HealthEvents | : | |
|---|---|---|
| | SourceId | : System.Hosting |
| | Property | : Activation |
| | HealthState | : Ok |

| | |
|---|---|
| SequenceNumber | : 130743727751456915 |

| | |
|---|---|
| SentAt | : 4/24/2015 6:12:55 PM |
| ReceivedAt | : 4/24/2015 6:13:03 PM |
| TTL | : Infinite |
| Description | : The ServicePackage was activated |

successfully.

| | |
|---|---|
| RemoveWhenExpired | : False |

| | |
|---|---|
| IsExpired | : False |
| Transitions | : −>Ok = 4/24/2015 6:13:03 PM |
| SourceId | : System.Hosting |
| Property | : CodePackageActivation:Code:EntryPoint |
| HealthState | : Ok |

| | |
|---|---|
| SequenceNumber | : 130743727751613185 |

| | |
|---|---|
| SentAt | : 4/24/2015 6:12:55 PM |
| ReceivedAt | : 4/24/2015 6:13:03 PM |
| TTL | : Infinite |
| Description | : The CodePackage was activated successfully. |

| | |
|---|---|
| RemoveWhenExpired | : False |

| | |
|---|---|
| IsExpired | : False |
| Transitions | : −>Ok = 4/24/2015 6:13:03 PM |
| SourceId | : System.Hosting |
| Property | : |

ServieTypeRegistration:WordCountServiceType

| | |
|---|---|
| HealthState | : Ok |

| | |
|---|---|
| SequenceNumber | : 130743727753644473 |

| | |
|---|---|
| SentAt | : 4/24/2015 6:12:55 PM |
| ReceivedAt | : 4/24/2015 6:13:03 PM |
| TTL | : Infinite |
| Description | : The ServiceType was registered successfully. |

| | |
|---|---|
| RemoveWhenExpired | : False |

| | |
|---|---|
| IsExpired | : False |
| Transitions | : −>Ok = 4/24/2015 6:13:03 PM |

IV. Adding Custom Service Fabric Health Reports

Service Fabric introduces a Health Model designed to flag unhealthy cluster or application conditions on specific entities. This is accomplished by using health reporters (System components and watchdogs) 402. A goal is easy and fast diagnosis and repair. Service writers are encouraged to think upfront about system health. Any condition that can impact health should be reported on, especially if a report can help flag problems close to their roots. This can save a lot of debugging and investigation once the service is up and running at scale in the cloud (private or not).

The Service Fabric reporters monitor identified conditions of interest. They report on those conditions based on their local view. The Health Store aggregates health data sent by all reporters to determine whether entities are globally healthy. The model is intended to be rich, flexible and easy to use. The quality of the health reports determines how accurate the health view of the cluster is. False positives that show unhealthy issues wrongly can negatively impact upgrades or other services that use health data, like repair services or alerting mechanisms. Therefore, some thought is needed to provide reports that capture conditions of interest in the best possible way.

To design and implement health reporting, watchdogs and System components define the condition they are interested in, the way it is monitored and the impact on the cluster/application functionality. This defines the health report property and health state. They also determine the entity 210 the report applies to, and determine where the reporting is done from, either from within service, via internal or external watchdog. They define a source used to identify the reporter. They choose a reporting strategy, e.g., reporting either periodically or on transitions. Reporting periodically involves simpler code and is therefore less prone to errors. Reporting components also determine how long the report for unhealthy conditions should stay in health store and how it should be cleared. This defines the report time to live and remove on expiration behavior.

Reporting can be done from the monitored Service Fabric service replica, and/or from internal watchdogs deployed as a Service Fabric service, e.g., a Service Fabric stateless service that monitors conditions and issues report. The watchdogs can be deployed on all nodes or can be affinitized to the monitored service.

Once the health reporting choices are made, sending health reports is easy. It can be done through API using FabricClient.HealthManager.ReportHealth, through PowerShell or through REST. Internally, all methods use a health client contained inside a fabric client. There are configuration knobs to batch reports for improved performance.

The health reports are sent to the Health Store using a health client, which lives inside the fabric client. The health client can be configured with settings such as:

HealthReportSendInterval. The delay between the time the report is added to the client and the time it is sent to Health Store. This is used to batch reports in a single message rather than send one message per each report, for improved performance. Default: 30 seconds.
HealthReportRetrySendInterval. The interval at which the health client re-sends accumulated health reports to Health Store. Default: 30 seconds.
HealthOperationTimeout. The timeout for a report message sent to Health Store. If a message times out, the health client retries until the Health Store confirms that the reports have been processed. Default: 2 minutes.

The buffering on the client takes the uniqueness of the reports into consideration. For example, if a particular bad reporter is reporting one hundred reports per second on the same property of the same entity, the reports will get replaced with last version. At most one such report exists in the client queue. If batching is configured, the number of reports sent to the Health Store is just one per send interval, the last added report, which reflects the most current state of the entity. All configuration parameters can be specified when creating the FabricClient, by passing FabricClientSettings with desired values for health related entries.

To ensure that unauthorized services can't report health against the entities in the cluster, the server can be configured to accept only requests from secured clients. Since the reporting is done through FabricClient, this means the FabricClient must have security enabled in order to be able to communicate with the cluster, e.g., with Kerberos or certificate authentication.

Design Health Reporting

A first step in generating high quality reports is identifying conditions 228 that can impact the health of the service. Any condition that can help flag problems in the service or cluster when they start or even better, before they happen, can be valuable, in terms such as less down time, less night hours spent investigating and repairing issues, higher customer satisfaction.

Once the conditions are identified, watchdog writers decide how to monitor them for an acceptable balance between overhead and usefulness. For example, consider a service that does some complex calculations using some temporary files on a share. A watchdog could monitor the share to make sure enough space is available. It could listen for notifications for file/directory changes. It can report a warning if an up-front threshold is reached and error if the share is full. On warning, a repair system could start cleanup of older files on the share. On error, a repair system could move the service replica to another node. Note how the condition states are described in terms of health: what is the state of the condition that can be considered healthy or unhealthy (warning or error).

Once the monitoring settings are chosen, watchdog writers decide how to implement the watchdog. If the conditions can be determined from within the service, the watchdog can be part of the monitored service itself. For example, the service code can check the share usage and report using a local fabric client every time it tries to write a file. The advantage of this approach is that reporting is simple. Care should be taken to prevent watchdog bugs from impacting the service functionality.

Reporting from within the monitored service is not always an option. A watchdog within the service may not be able to detect the conditions: either it doesn't have the logic or data to make the determination, or the overhead of monitoring the conditions is high, or the conditions are not specific to a service, but affect interactions between services. Another option is to have watchdogs in the cluster as separate processes. The watchdogs simply monitor the conditions and report, without affecting the main services in any way. These watchdogs could for example be implemented as stateless services in the same application, deployed on all nodes or on the same nodes as the service.

Sometimes, a watchdog running in the cluster is not an option either. If the monitored conditions are the availability or the functionality of the service as users see it, it is better to have the watchdogs in the same place as the user clients, testing the operations in the same way users call them. For example, one can have a watchdog living outside the cluster and issuing requests to the service, checking the latency and the correctness of the result, e.g., for a calculator service, does 2+2 return 4 in a reasonable time?

Once the watchdog details have been finalized, developers decide a source id that uniquely identifies the watchdog. If multiple watchdogs of the same type are living in the cluster, they either report on different entities, or if they report on the same entity, the source id or the property is different, so reports can coexist. The property of the health report should capture the monitored condition. Thus, for the example above, the property could be ShareSize. If multiple data applied to the same condition, the property should contain some dynamic information to allow reports to coexist. For example, if there are multiple shares that need to be monitored, the property name can be ShareSize-sharename.

In general, the health store should not be used to keep status information. Only health related information should be reported as health, namely, information that impacts the health evaluation of an entity. The implemented health store was not designed as a general purpose store. It uses health evaluation logic to aggregate all data into health state. Sending non-health related information (e.g., reporting status with health state Ok) will not impact aggregated health state, but can negatively affect the performance of the health store.

The next decision point is what entity to report on. Most of the time, this is clear based on the condition. Choose the entity with finest granularity possible, e.g., one furthest from the root of the hierarchy. If a condition impacts all replicas in a partition, report on the partition, not on the service. However, there are exceptions. If the condition impacts an entity (e.g., replica) but the desire is to have the condition flagged for more than replica life duration, report it on the partition level of granularity. Otherwise, when the replica is deleted, all reports associated with it are cleaned up from store. This means watchdog writers also think about the lifetime of the entity and of the report. Attention is to be paid to when a report will be cleaned up from a store, e.g., when an Error reported on an entity does not apply anymore.

Let's look at an example to put together the above points. Consider a Service Fabric application composed of a Master stateful persisted service and Slaves stateless services deployed on all nodes (one Slave service type for a type of task). The Master has a processing queue with commands to be executed by slaves. The slaves execute the incoming requests and send back Acks. One condition that could be monitored is Master processing queue length. If the master queue length reaches a threshold, report Warning, as that means the slaves can't handle the load. If the queue reached max length and commands are dropped, report Error as the service can't recover. The reports can be on property “QueueStatus”. The watchdog lives inside the service and it's sent periodically on the Master primary replica. The TTL is 2 minutes and it's sent periodically every 30 seconds. If the primary goes down, the report is cleaned up automatically from store. If the service replica is up but deadlocked or having other issues, the report will expire in the health store and the entity will be evaluated at error.

Another condition that can be monitored is task execution time. The Master distributes the tasks to the slaves based on the task type. Depending on the design, the Master could poll the slaves for task status or it could wait for slaves to send back ACKs when done. In the second case, care must be taken to detect situations where slaves die or messages get lost. One option is for Master to send a ping request to the same Slave, which sends back the status. If no status is received, consider failure and re-schedule the task. This assumes that the tasks are idempotent. One can translate the monitored condition as warning if task is not done in a certain time t1 (e.g., 10 minutes) and error if the task is not completed in time t2 (eg. 20 minutes). Reporting can be done in multiple ways.

One way is having the Master primary replica report periodically on itself. There could be a property for all pending tasks in the queue: if at least one task takes longer, report on property “PendingTasks” warning or error, as appropriate. If there are no pending tasks or all are just started, report Ok. The tasks are persisted, so if primary goes down, the new promoted primary can continue to report properly.

Another way is have a watchdog process (in the cloud or external) check the tasks (from outside, based on desired task result) to see if they are completed. If they do not respect the thresholds, report on Master service. Report on each task and include the task identifier (eg: PendingTask+taskid). Report only on unhealthy states. Set TTL to a few minutes and mark the reports to be removed when expired to ensure cleanup.

The slave that is executing a task is reporting if it takes longer than expected to run it. It reports on the service instance on property “PendingTasks”. This pinpoints the service instance that has issues, but it doesn't capture the situation where the instance dies. The reports are cleaned up at that time. It could report on the Slave service; if the Slave completes the task, the slave instance clears the report from store. This doesn't capture the situation where the ack message is lost and the task is not finished from Master point of view.

However the reporting is done in the cases described above, they will be captured in application health when health is evaluated.

As to reporting periodically vs. on transition, consider the following.

Using the health reporting model, watchdogs can send reports periodically or on transitions. With periodic reporting, the code is much simpler, therefore less error prone. The watchdogs strive to be as simple as possible to avoid bugs which trigger wrong reports. Incorrect unhealthy report will impact health evaluation and scenarios based on health, like upgrades. Incorrect healthy reports hide issues in the cluster, which is not desired.

For periodic reporting, the watchdog can be implemented with a timer. On timer callback, the watchdog can check the state and send a report based on current state. There is no reason to see what report was sent previously or make any optimization in terms of messaging. The health client has batching logic to help with that. As long as the health client is kept alive, it will retry internally until the report is ACKed by the health store or the watchdog generates a newer report with the same entity, property and source.

Reporting on transition calls for careful state handling. The watchdog monitors some conditions and only reports when the conditions change. The plus side is that fewer reports are likely to be sent. The minus is that the logic of the watchdog is complex. The conditions or the reports are maintained so they can be inspected to determine state changes. On failover, care is taken to send a report which may have not been sent previously (queued, but not yet sent to health store). The sequence number is always increasing, or the reports will be rejected due to staleness. In the rare cases where data is lost, one may synchronize the state of the reporter and the state of the health store.

In one implementation, the entities 206 are created by the system components and not by users. The entities are only visible if they and all parents are reported on by system components. Internally, this health store 218 maintains some attributes that allows it to determine the hierarchy. Other than the “Parent-Child” relationship described above, one may define “virtual” relationships between node and the entities deployed on that node. If a node is down as detected by System components, it will impact all replicas, deployed applications and deployed service packages deployed on it. Those resources 210 are moved to another, healthy node (or this node, after it comes back again). The health store cleans up the entities 206 that are not valid anymore based on the revised system 102 hierarchy. When an entity 206 is deleted, all reports 212 associated with it are removed.

In some implementations, an entity has an instance ID 502, which may be a GUID or a sequence number, for example. When an entity is deleted, the health store automatically deletes all health reports associated with the entity. When a new instance of the entity is created, a new instance ID is assigned, and all reports associated with the old instance are deleted from health store.

Some Additional Combinations and Variations

Any of these combinations of code, data structures, logic, components, signals, signal timings, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the medium combinations and variants describe above.

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIGS. 4 and 7-9 also help describe configured media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable medium, and/or other example of the teachings herein as applied in a manner consistent with applicable law.” Accordingly, a given “embodiment” may include any combination of features disclosed herein, provided the embodiment is consistent with at least one claim.

Two different reference numerals may be used in reference to a given item in some cases, when one of the numerals designates a particular subset of a broader group that is designated by the other numeral. For example, a first reference numeral may designate services generally while a second reference numeral designates a particular service, or a first reference numeral may designate a category of items while a second reference numeral designates a particular item in that category.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used.

As used herein, terms such as “a” and “the” are inclusive of one or more of the indicated item or step. In particular, in the claims a reference to an item generally means at least one such item is present and a reference to a step means at least one instance of the step is performed. Also, “/” may be used herein as an abbreviation of “and/or”, such that text of the form “x/y” means “x and/or y”.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A process for reporting health in a distributed computational system, comprising:
creating health entities in a hierarchy, each health entity representing a health state of a corresponding computational resource in the distributed computational system, the hierarchy residing at least partially in a digital memory and created at least partially by operation of a digital processor;
associating health conditions with at least some of the health entities; and
when a health condition is detected in the distributed computational system, reporting the health condition to a health store by sending a health report which identifies a focus of the health condition, namely, identifies one or more health entities each of which has the finest granularity of any health entity associated with the health condition.

2. The process of claim 1, wherein the process is further characterized in at least two of the following ways:
the health entities include a cluster health entity, and a split-brain health condition is associated with the cluster health entity;
the health entities include a node health entity, and a no-more-disk-space health condition is associated with the node health entity;
the health entities include a node health entity, and a no-more-memory health condition is associated with the node health entity;
the health entities include a node health entity, and a no-more-connections health condition is associated with the node health entity;
the health entities include an application health entity, and an end-to-end-services-interaction-failure health condition is associated with the application health entity;
the health entities include a service health entity, and a service-misconfiguration health condition is associated with the service health entity;
the health entities include a service_partition health entity, and an insufficient-replicas health condition is associated with the service_partition health entity;
the health entities include a service_partition health entity, and a quorum-loss health condition is associated with the service_partition health entity;
the health entities include a replica health entity, and a cannot-replicate-to-secondary health condition is associated with the replica health entity;
the health entities include a replica health entity, and a slowed-replication health condition is associated with the replica health entity;
the health entities include a replica health entity, and an insufficient-resources health condition is associated with the replica health entity;
the health entities include a replica health entity, and a bad-connectivity health condition is associated with the replica health entity;
the health entities include a deployed_application health entity, and a cannot-download-application-package health condition is associated with the deployed_application health entity;
the health entities include a deployed_application health entity, and an application-security-principals health condition is associated with the deployed_application health entity;
the health entities include a deployed_application health entity, and a service-type-registration-failed health condition is associated with the deployed_application health entity;
the health entities include a deployed_service_package health entity, and a missing-library health condition is associated with the deployed_service_package health entity;
the health entities include a deployed_service_package health entity, and cannot-start-code-package health condition is associated with the deployed_service_package health entity; or
the health entities include a deployed_service_package health entity, and cannot-read-configuration-package health condition is associated with the deployed_service_package health entity.

3. The process of claim 2, wherein the process is characterized in at least five of the listed ways.

4. The process of claim 1, wherein the process is further characterized in at least one of the following ways:
the hierarchy includes a cluster health entity, and also includes at least one node health entity which is a descendant of the cluster health entity;
the hierarchy includes a cluster health entity, and also includes at least one application health entity which is a descendant of the cluster health entity;
the hierarchy includes an application health entity, and also includes at least one deployed_application health entity which is a descendant of the application health entity;
the hierarchy includes a deployed_application health entity, and also includes at least one deployed_service_package health entity which is a descendant of the deployed_application health entity;
the hierarchy includes an application health entity, and also includes at least one service health entity which is a descendant of the application health entity;
the hierarchy includes a service health entity, and also includes at least one service_partition health entity which is a descendant of the service health entity; or
the hierarchy includes a service_partition health entity, and also includes at least one replica health entity which is a descendant of the service_partition health entity.

5. The process of claim 4, wherein the hierarchy includes at least one health entity which is designated as a host of at least one other health entity, hereby denoted the hosted entity, and when the host becomes unhealthy the hosted entity automatically becomes unhealthy.

6. The process of claim 1, wherein reporting the health condition comprises reporting at least the following: a reporter ID, a health entity ID, a health property of the health entity, and a health state of the health property.

7. The process of claim 1, further comprising aggregating health states of one or more descendants of a parent health entity while following a health policy, thereby modifying a health state of the parent health entity.

8. The process of claim 1, wherein the process supports health evaluation of the distributed computational system while avoiding diagnostic clamoring, namely, avoiding use of a high-level monitor which receives all diagnostic information emitted by monitors and watchdogs.

9. The process of claim 1, further comprising barring users from reporting in a system role, and preventing users from using system role reports to create health entities.

10. A computer-readable storage medium configured with data and with instructions that when executed by at least one processor causes the processor(s) to perform a technical process for reporting health in a distributed computational system, the process comprising:
creating health entities in a hierarchy, each health entity representing a health state of a corresponding computational resource in the distributed computational system, the health entities including at least three of the following: a cluster health entity, a node health entity, an application health entity, a service health entity, a service_partition health entity, a replica health entity, a deployed_application health entity, or a deployed_service_package health entity;
associating health conditions with at least some of the health entities; and
when a health condition is detected in the distributed computational system, reporting the health condition to a health store by sending a health report which identifies a focus of the health condition, namely, identifies one or more health entities each of which has the least coarse granularity of any health entity associated with the health condition.

11. The computer-readable storage medium of claim 10, wherein the health report includes at least the following: a reporter ID, a health entity ID, a health property of the health entity, a health state of the health property, and a human-readable health event description.

12. The computer-readable storage medium of claim 10, wherein the process further comprises using health reports which are stored in the health store as a basis for at least one of the following:
performing a monitored upgrade to at least a portion of the distributed computational system; or
alerting a human administrator to a condition in at least a portion of the distributed computational system.

13. The computer-readable storage medium of claim 10, wherein the process further comprises using health reports which are stored in the health store as a basis for at least one of the following:
making an automatic repair to at least a portion of the distributed computational system; or
diagnosing a performance problem in at least a portion of the distributed computational system.

14. The computer-readable storage medium of claim 10, wherein the process further comprises limiting reporting against a given health entity to reporting by reporters which have a specified permission.

15. A computer system comprising:
a logical processor;
a memory in operable communication with the logical processor;
a hierarchy of health entities residing at least in part in the memory, each health entity representing a health state of a corresponding computational resource in a distributed computational system, the health entities including at least four of the following: a cluster health entity, a node health entity, an application health entity, a service health entity, a service_partition health entity, a replica health entity, a deployed_application health entity, or a deployed_service_package health entity; and
a replicated health store containing health reports, each health report including at least a health entity ID of one of the health entities, a health property of the health entity, and a health state of the health property, the health entity IDs identifying one or more health entities each of which has the finest granularity of any health entity that is associated with a health condition that is reported by the health report.

16. The system of claim 15, wherein the health reports include at least one user-generated health report.

17. The system of claim 15, wherein the health store includes code which upon deletion of an instance of a health entity automatically deletes all health reports associated with that instance.

18. The system of claim 15, wherein the health states include an okay state indicating there are no known health issues, a warning state indicating there is at least one health issue but it does not exceed a predetermined threshold, and an error state indicating that an entity in the distributed computational system is unhealthy.

19. The system of claim 15, wherein at least two of the following health conditions are each associated with at least one respective health entity: split-brain, no-more-disk-space, no-more-memory, no-more-connections, quorum-loss, cannot-replicate-to-secondary, slowed-replication, insufficient-resources, bad-connectivity, cannot-download-application-package, service-type-registration-failed, missing-library, cannot-start-code-package, cannot-read-configuration-package.

20. The system of claim 15, wherein the system further comprises at least one of the following: a reporter configured to periodically send health reports which are each subject to a respective time-to-live, a reporter configured to send health reports in a numbered sequence with each health report sent only once.
